(19) United States
(12) Patent Application Publication
(10) Pub. No.: US 2007/0220415 A1
(43) Pub. Date: Sep. 20, 2007

(54) Excel spreadsheet parsing to share cells, formulas, tables or entire spreadsheets across an enterprise with other users

(76) Inventors: Morgan Mao Cheng, Fremont, CA (US); Alistair D'Lougar Black, Los Gatos, CA (US); Michael L. Milton, Fremont, CA (US)

Correspondence Address: RONALD CRAIG FISH, A LAW CORPORATION, PO BOX 820, LOS GATOS, CA, 95032, US

(21) Appl. No.: 11/396,121

(22) Filed: Mar. 31, 2006

Related U.S. Application Data
(63) Continuation-in-part of application No. 11/384,152, filed on Mar. 16, 2006.

(51) Int. Cl. G06F 15/00

(52) U.S. Cl. 715/503

(57) ABSTRACT

Discloses a method and apparatus and user interface for parsing individual objects of a spreadsheet created on a client computer and sending the entire workbook, its binary and the objects for storage on a server computer in a master library. The master library can be opened, searched and objects downloaded. The downloaded object can have their metadata displayed, and the level of detail about each object that is downloaded can be controlled by the user. The user can designate objects for sharing in the master library with other spreadsheet users. Downloaded objects can be modified with the native tools of the spreadsheet application, typically Excel, and re-stored in the master library under a different name and with the person who changed the object listed in the metadata as the owner. Searches can controlled by user interface tools to designate object type to search, and search type can be by owner or functional area of the company. Users can enter their own metadata. Automatic naming of objects decouples objects from their original locations in the workbooks upon which they were created.

This is a contination-in-part application of a patent application entitled EXCEL SPREADSHEET PARSING TO SHARE CELLS, FORMULAS, TABLES, ETC., Ser. No. ______, filed Mar. 16, 2006, Express Mail Number EV423637560 US, which is hereby incorporated by reference.

### BACKGROUND OF THE INVENTION

The Excel spreadsheet application is one of the most widely installed and used application programs in business worldwide. Many users create tables which contain data specific to their businesses and create special formulas in particular cells of their spreadsheets that are unique to the kinds of processing or analysis of data that the user does in his or her job.

Frequently, the Excel spreadsheet is used by many users in the same large corporation or government entity. Sharing of entire spreadsheets can be accomplished by saving the spreadsheet on a server or other computer to which other users who wish to share the spreadsheet have access privileges.

However, sharing of entire spreadsheets is not as useful as the ability to share individual formulas, tables, cells of spreadsheets. Many users in organizations generate very complex spreadsheets with tables of data, specialized formulas developed by the user to process data in the form of constants and variables to make various calculations necessary for the operations of a corporation or other entity. For example, several members of a corporation's finance department may have developed spreadsheets with formulas for calculating net profit of the corporation, net profit on specific product lines, tables of data pertaining to cost of goods sold, etc. These formulas and tables usually are developed as part of larger spreadsheets these users have developed to do their jobs.

Other members of the corporation may wish to use these individual formulas or tables for one reason or another. At the present time, the applicants are not aware of any prior art which will allow sharing of individual cells, tables, formulas of spreadsheets. Since there is much valuable information in individual components of larger spreadsheets, and it is wasteful and inefficient for other users to have to develop the same formulas, tables and cells other users have already developed, a need has arisen for a system which can parse spreadsheets and upload individual cells, formulas and tables to a central shared master library where these formulas, cells and tables can be shared by other users, modified by them and re-published to a master library for sharing.

One disadvantage of Excel is that there is a size limitation. No spreadsheet can have more than 64,000 pages or workbooks. While this may sound like a lot, in some organizations, this actually is not enough to do the processing desired by some users. There is a need for a system which can bypass this size limitation.

### SUMMARY OF THE INVENTION

A system according to the broadest teachings of the invention provides a software system, which when executed on a computer, provides the functionality and a computer user interface as combination and subcombination to: 1) parse individual objects that make up a spreadsheet workbook and name them; 2) store those objects in a central repository; 3) designate said objects as shared for reuse by others or the original owner thereof; 4) allow the central repository to be opened and allow objects therein to be analyzed and searched to find objects suitable for a user's purpose; 5) allow shared objects to be downloaded into spreadsheets and reused there. In the preferred embodiment within this genus of inventions an Excel driven master data management system is provided which enables sharing of data, models and spreadsheets across an enterprise and enables consistent descriptions thereof in a master library which other users can access. The master library is any repository or persistance mechanism that multiple users can access via any data path and which stores objects parsed from spreadsheets or workbooks. Individual tables of cells, individual cells including values or constants or formulas including nested formulas can be uploaded from the master library into spreadsheets being created by other users. The term “object” as used in the claims included herewith includes spreadsheets, workbooks, templates (workbooks which have been prefilled with predefined objects), tables of cells, individual cells including values, constants, formulas and the relationships created by reference to other cells in formulas. The terms “spreadsheet” and “workbook” are used as meaning the same thing herein despite the fact that a spreadsheet can be comprised of multiple workbooks. So when a client speaks of doing anything with or to or regarding a spreadsheet, it should be understood as also doing the same thing with, to or regarding a workbook. The broadest genus of the invention is not limited to Excel spreadsheets or workbooks, and any type spreadsheet application program can be used as the teachings of the invention contemplate parsing workbooks into objects and allow various operations to be performed regarding the objects and providing a user interface on a computer to control these operations.

However, the preferred embodiments within the genus of the invention enhance the capabilities of Excel spreadsheet users. Software according to the preferred embodiments: 1) adds user interface menu options to Excel spreadsheets and the necessary functionality to open the master library and provide search and analysis capabilities to select the best object for the needs of the user and return the object and any data and/or formulas contained therein (at the option of the user) to a workbook being constructed on the users computer; 2) save a workbook to the master library including parsing and naming all the objects; 3) share workbooks designated by the owner thereof and by doing so, the objects in the designated workbook are individually shared; 4) refresh a workbook so as to import all changes made to objects owned by others which have been imported from the master library such that any changes in values, constants, formulas for a cell or changes to the number of rows and/or columns in a table and any changes to cells within the table are imported into the workbook; 5) provide user interface mechanisms and the underlying functionality to capture and store metadata created by a user for an object and the functionality to capture any other metadata pertaining to an object created by Excel or metadata created by other systems which created fields and values which have been imported into the master library; 6) provide the ability to use Excel native functionality to modify cells and tables which have been imported from the master library and store and share the changed objects where the changed objects, in the case where the changed object was orginally created by the person who changed it, can be stored as a modified version of the original object or as a new object, or, in the case where the object changed was originally created by somebody else, the object can be stored only as a new object with a new owner. In some embodiments, the user can drag cursors or other user interface mechanism to outline or change the boundaries of a table object to define a new object.

A system according to the invention has a user interface mechanism implemented by a computer which allows a user to invoke a command to save a spreadsheet to a master library and which allows a user to open the master library and import objects stored therein into a spreadsheet on the user's computer.

Typically, the user's computer is a client computer on a network, and the master library is stored on a server, but that need not always be the case. The client computer and the server computer could be the same computer in some embodiments and other client computers could couple to the server computer to upload and download spreadsheet objects.

Typically the user interface mechanisms are menus and icon selections, pointing devices, and hyperlinks, but other user interfaces such as speech recognition coupled with audio output can also be used alone or in addition to graphically displayed menus and icon selections. The phrase “using a computer to implement a user interface mechanism” refers to using the computer to display the user interface menu or icon and to receive user selections and/or to speak options a user has and do speech recognition of the user's responses or any of way of communicating information to the user and receiving responses from the user. The phrase is not intended to mean the underlying computer processing to implement the functionality required by the user's choices. That functionality will be claimed separate and apart from the user interface aspects of the invention.

In embodiments where the user interface includes mechanisms to open the master library, user interface mechanisms to permit the master library to be searched are presented. In the preferred embodiments, the user interface search mechanisms allows the user to choose whether to search for tables, cells, workbooks or templates and to choose a method of search including: browse, advanced search or text search, and allows the user to select whether to conduct the search by functional area of a company or by owner of the object. Area of the company where a spreadsheet object was created and the owner of the object are specified in metadata for the object stored in the master library.

In other embodiments, in addition to the above mentioned two user interface mechanisms (save to master library and open master library) user interface mechanisms to refresh a spreadsheet and share a spreadsheet already stored to the master library are presented.

By parsing spreadsheets created by various users within a company, it is possible to share models and data across the company. This allows Excel models generated by various skilled users for such things as calculating profit and loss, inventory, etc. to be used by other users in the company to do the same things consistently by virtue of using the same model and the same data. This is done by downloading a primitive (also referred to as objects herein) for the function of interest from a master library of spreadsheet cells, tables, or entire workbooks generated by other users. The primitive so downloaded is the model for the function of interest. The primitives or objects stored in the master library can be stored there in at least two ways. The first way is the object is previously generated in an Excel spreadsheet by another user using standard Excel capabilities. That workbook is then uploaded to the master library by the parsing process for sharing. The other way for objects to get stored in the master library is by back-end data and data model integration. This means fields (cells called fields in another system) and values (constants or formulas in the cell) from another repository are mapped to the master library via a published API. Full tables may also be imported from another system. By sharing models and data using the master library, a corporate standard is created for models and data for various functions.

In some embodiments, everybody's spreadsheet data, tables and cells are stored in the master library. The owner of an object stored in the master library can choose to share the object with others or not. Another user searching the master library can only access objects which have been designated as shared. The other user must sort through the various models or tables to do the same function and pick the best one. In other embodiments, a librarian picks out the best models and only allows those to stay in the master library.

A naming protocol is used to automatically give each cell, table or other primitive a name in the master library so as to free it from its location on the original spreadsheet and to give it more meaning to another user who did not create the object. This naming protocol enables mapping objects stored in the master library to locations in the spreadsheet from which the objects came. The naming of the cell or table is done automatically (with some user interaction) by the preferred embodiment as part of the parsing process. For example, a user may have created a five column table, but chooses to designate only the first four columns as the object to be shared.

One advantage of such a master library is that it enables users of Excel spreadsheets to overcome the 64,000 row limitation of legacy versions of Excel. It is possible in newer versions of Excel, there may be a higher limit or no limits at all. While this may seem like a large number of workbooks, it actually is a limitation in some applications where users have developed extremely large spreadsheets and have been hindered by the limitation.

A system according to the preferred embodiment will have a plurality of client computers upon which will be developed spreadsheets designed by users of those computers. An Excel add-in program is installed on each of these client computers. The add-in in combination with a backend server process which manages the master library functions to: 1) adds user interface menu options and the necessary functionality to open the master library and provide search and analysis capabilities to select the best object for the needs of the user and return the object and any data and/or formulas contained therein (at the option of the user) to a workbook being constructed on the users computer; 2) save a workbook to the master library including parsing and naming all the objects; 3) share workbooks designated by the owner thereof and by doing so, the objects in the designated workbook are individually shared; 4) refresh a workbook so as to import all changes made to objects owned by others which have been imported from the master library such that any changes in values, constants, formulas for a cell or changes to the number of rows and/or columns in a table and any changes to cells within the table are imported into the workbook; 5) provide user interface mechanisms and the underlying functionality to capture and store metadata created by a user for an object and the functionality to capture any other metadata pertaining to an object created by Excel or metadata created by other systems which created fields and values which have been imported into the master library; 6) to allow the user to use Excel native functionality to modify cells and tables which have been imported from the master library and store and share the changed objects where the changed objects, in the case where the changed object was orginally created by the person who changed it, can be stored as a modified version of the original object or as a new object, or, in the case where the object changed was originally created by somebody else, the object can be stored only as a new object with a new owner.

The interchange server is coupled to the client computers by any data path. Typically, a librarian controls the interchange server to help organize, categorize and describe the “primitives” uploaded from spreadsheets on client computers. In some embodiments, third party content can be uploaded into the master library to enrich the collection of primitives available to share.

### BRIEF DESCRIPTION OF THE DRAWINGS

FIG. 1 is a high level diagram showing the concepts of client computers running Excel add-ins to parse spreadsheets and upload cells, formulas and tables to an interchange server and to download primitives stored in said server to spreadsheets being composed in the client computers.

FIG. 2 is a pseudo flowchart illustrating the steps of a typical process for creating a new spreadsheet using primitives downloaded from the master library and editing said primitives to suit the needs of the author and publishing the primitives of the completed spreadsheet back to the master library.

FIG. 3 is a screenshot illustrating the first step in a process of using an embodiment to create a new spreadsheet using the primitives master library.

FIG. 4 is screenshot of the Excel spreadsheet showing how the menu structure has been modified to add the BDNA functionality added by the Excel plug in to enable downloading primitives from the master library and uploading and sharing spreadsheets composed by the user.

FIG. 5 is a screenshot of a typical display which the Excel add-in causes to be displayed when the Open Master Library Option is selected.

FIG. 6 is a screenshot of a screen which is displayed when the user chooses to search by owner for primitives in the master library.

FIG. 7 is screenshot of a screen which appears in the preferred embodiment when the user chooses to browse tables in the master library by functional area.

FIG. 8 is a more detailed view of the table 32 of FIG. 7 which illustrates the user interface of the preferred embodiment which can be used to sort or filter the primitives in the master library, preview a particular primitive in the respository, select a primitive for return to the spreadsheet under construction or drill down into a primitive to see more details about the primitive.

FIG. 9 is a screenshot of the type of screen which is displayed in the preferred embodiment after the user has selected a particular table in FIG. 8 and selected the preview button.

FIG. 10 is a screenshot of the options display which the Excel add-in causes the client computer to display when the user chooses to return a primitive from the master library to the spreadsheet under construction.

FIG. 11 is a screenshot of the client computer's spreadsheet application after a primitive from the master library has been selected and returned to the spreadsheet under construction.

FIG. 12 is a screenshot of the display on the client computer rendered by the combination of the Excel plugin and the Excel spreadsheet application which illustrates how a user can drill down to inspect the formula behind a particular cell in the table primitive imported from the master library.

FIG. 13 is a screenshot of the display that results when Formula Inputs tab 84 is selected in FIG. 12.

FIG. 14 is a screen shot of the display that results when the user chooses to add custom cells to a primitive that has been downloaded from the master library.

FIG. 15 is a screen shot of the user interface mechanism by which the user can give commands to open the BDNA Master Library, refresh the workbook, save the workbook to the master library master library or share the workbook.

FIG. 16 is a diagram of a table element in a spreadsheet that is to be parsed showing how the system automatically uses elements of the table to generate a name for the primitive to be-used in storing the primitive in the master library.

FIGS. 17A and 17B are a flowchart of the process of opening the master library and searching it.

FIGS. 18A and 18B are a flowchart of the process of viewing object details of objects stored in the master library.

FIG. 19 is a flowchart of he process to preview a table stored in the master library.

FIGS. 20A and 20B are a flowchart of the process to retrieve objects from the master library.

FIGS. 21A and 21b are a flowchart of the process to save workbooks and the individual objects therein in the master library.

FIG. 22 is a flowchart of the process of validating a user.

FIG. 23 is a flowchart of the process to define a table.

FIG. 24 is a flowchart of the process to share a workbook.

FIG. 25 is a flowchart of the process to refresh a workbook.

FIG. 26 is a software architecture diagram of the Excel plug in referred to in the diagram as a COM Excel Add-In because it is designed to use the COM interface to add functionality to Excel application programs.

FIG. 27 is a screen shot of a user interface screen.

### DETAILED DESCRIPTION OF THE PREFERRED AND ALTERNATIVE EMBODIMENTS

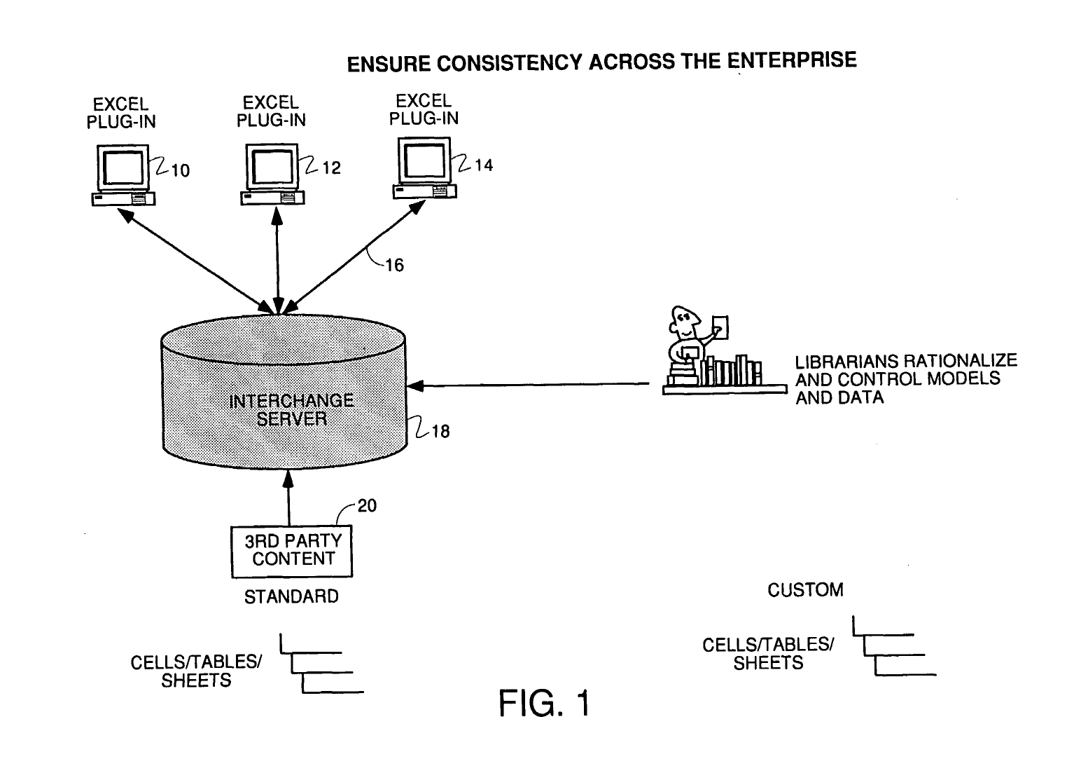

Referring to FIG. 1, there is shown a high level diagram showing the concepts of client computers 10, 12 and 14 running Excel add-ins, and communicating over a data network 16 with an interchange server 18. The Excel add-ins function to parse spreadsheets executing on the client computers into primitives comprised of individual cell contents, the formulas behind a cell or even the cell contents, formula behind the cell and all cells and other formulas referenced by the formula. The Excel add-ins function to control the client computers and enable them to parse Excel spreadsheets and upload the spreadsheets and their objects for storage in a master library on server 18.

The objects that make up a spreadsheet include but are not limited to: 1) its individual cells including formulas, constants or labels programmed into those cells and all inputs to formulas including hierarchically nested formulas; 2) tables and the contents of each row and column of said table. The parsing process maintains all interrelated values, cells, formulas, input to formulas and multi-level nested formulas and their inputs and tables (hereafter these individual components of a spreadsheet may be referred to as primitives as well as objects) so as to maintain a complete representation of any spreadsheet so parsed in the master library. In the preferred embodiment, each object is converted to an XML data representation packaged in a SOAP envelope and describes the object. This data structure of XML packaged in SOAP envelope is one which can be sent over network 16 to server 18.

The add-ins also control the client computers to enable them to download spreadsheets or individual primitives stored in a master library on said server to spreadsheets being composed in the client computers.

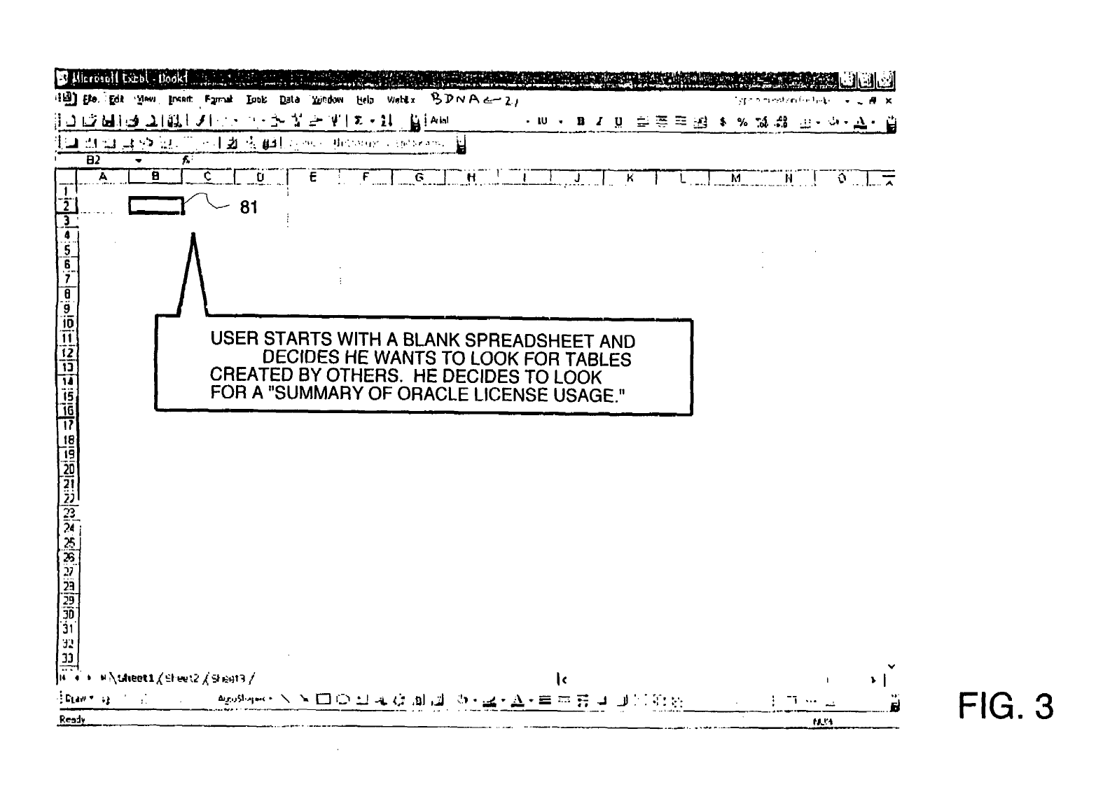

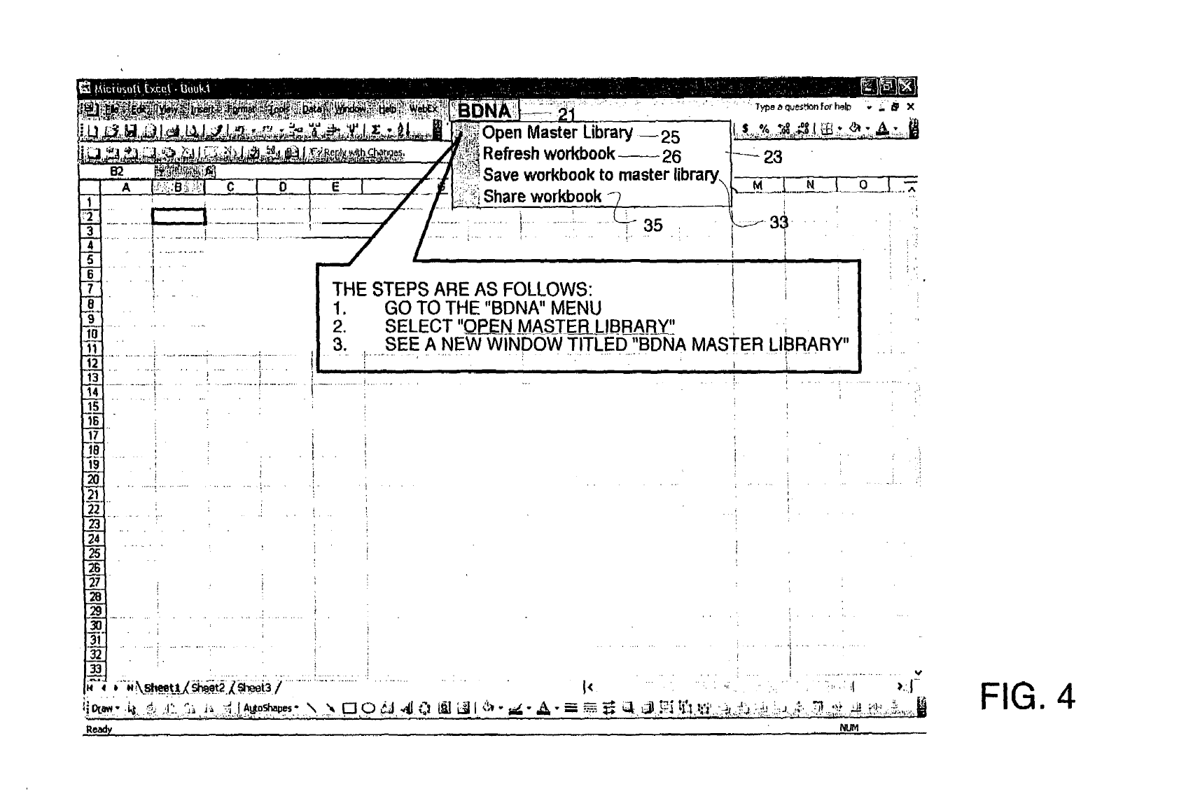

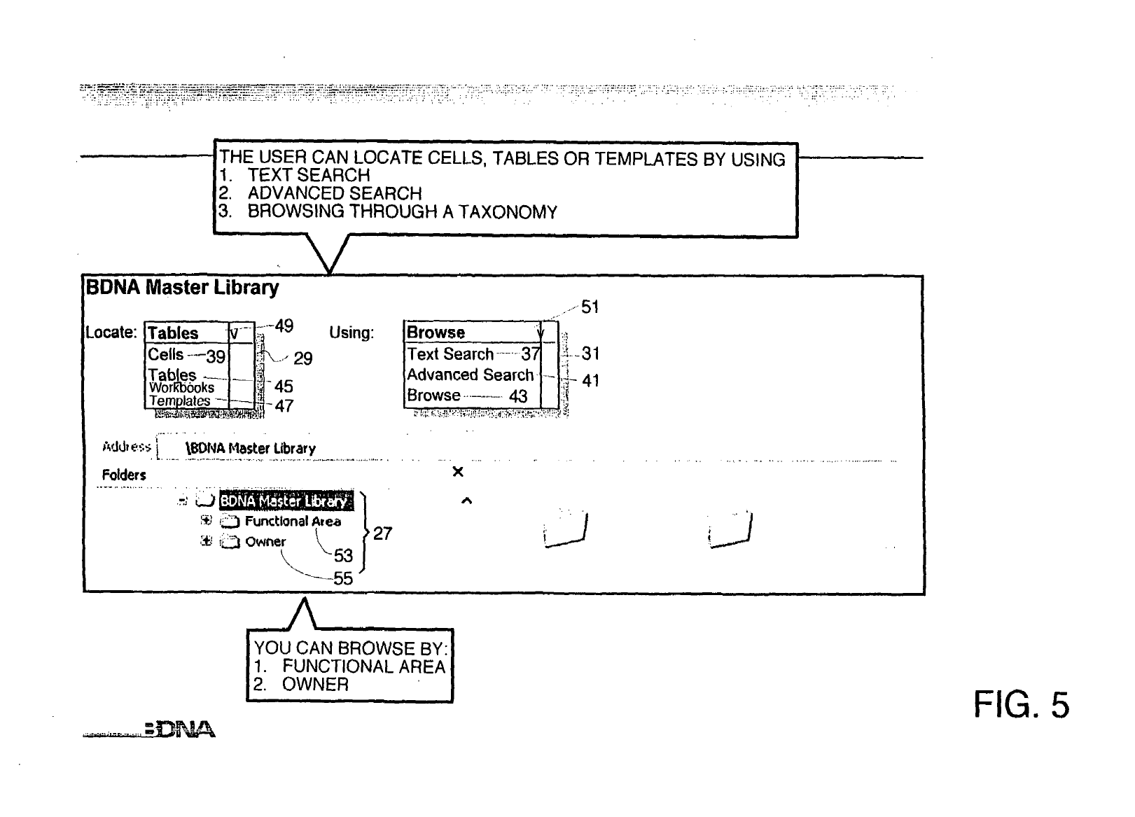

FIGS. 3 and 4 represent the Excel user interface although in FIGS. 3 and 4, the BDNA drop down menu options are shown. This menu option is provided by the Excel add-in or OLE object that adds BDNA master library functionality to Excel spreadsheets. FIGS. 5 and onward represent the unique user interface pages implemented by the BDNA Excel add-in in or integrated objects to deal with uploading primitives to the master library, sharing them, searching and filtering and inspecting them, and downloading primitives from the master library etc.

In some embodiments, third party content 20 such as libraries of formulas, tables etc. may be added by librarian 22 to the master library 18 to enrich the functionality of the collection of primitives stored in the master library.

Typical Process To Use The Invention

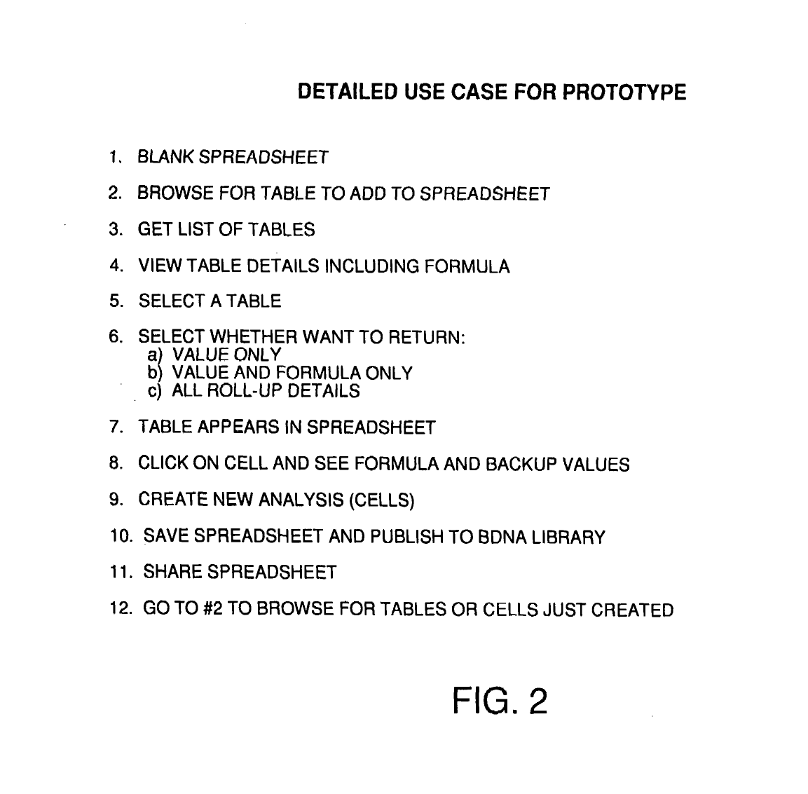

A typical process of using an embodiment is as illustrated in FIG. 2. FIG. 2 is a pseudo flowchart illustrating the steps of a typical process for creating a new spreadsheet using primitives downloaded from the master library and editing said primitives to suit the needs of the author and publishing the primitives of the completed spreadsheet back to the master library.

Step One: the user opens a blank workbook using Excel. This is done using conventional Excel processing.

Step Two: the user browses the master library for a table to add to the spreadsheet created in Step One. This step is accomplished by the Excel plug in controlling the client computer to establish a communication session with the interchange server 18 and invoking functionality of the interchange server to cause it to send data to the client computer which details a list of table primitives stored in the master library which are available for download. In the preferred embodiment, there are three ways to find objects in the master library: browsing tree structures; key word search of metadata of all objects in master library where the user specified key word is used to search all attribute fields of all metadata of all objects; and, attribute search where the values of each of one or more attributes in the metadata is specified by the user as the search term(s) and all objects which have the specified string(s) in the specified attribute field(s) will be returned as search results. It is data collected by Excel about a primitive and data gathered by the Excel plug in about a particular primitive and can include data supplied by the user in response to questions posed by the Excel add-in that the user answers.

Step Three: the user gets a list of tables, cells, spreadsheets etc. in the master library 18 which satisfy the search criteria.

Step Four: the user views a selected table including its formula details or views the details of the cell including any underlying formula or views the entire spreadsheet. This command brings a cell, table or entire spreadsheet into a formula and opens it for inspection but does not save the selected primitive into the spreadsheet under construction yet.

Step Five: the user selects a table, cell or spreadsheet for upload into the spreadsheet under construction based upon the inspection made in Step Four.

Step Six: when the user chooses to bring a cell or table into the spreadsheet, he or she has options. In the preferred embodiment, the Excel add-in will provide a popup form which provide user interface mechanisms which allow a user to issue commands to choose whether he or she wants to upload the value of a cell only, the cell value and formula that calculates that value; or all the roll-up details. The roll-up details include all the other cells that are referenced in the formula and any formulas in those cells and any cells referenced by those formulas.

Step Seven: after the selection is made, the table appears in the blank workbook of the spreadsheet created in Step One. This is done by the Excel add-in sending a message to the master library designating the primitive desired for downloading, and then receiving the data of the primitive in a series of network packets.

Step Eight: after the table appears in the blank workbook, the user can click on any cell and see the underlying formula and backup values which are creating the value displayed in the cell.

Step Nine: the user can use the Excel tools to modify the formula(s), add new cells, delete cells, etc. The Excel add-in is not necessary to do this. Typically, the Excel add-in will be functionality that is integrated into the Excell application by a COM or OLE interface. Thus, all the native functionality of Excel is still present and can be used to add new cells, formulas, tables etc. or modify existing cells, formulas or table regardless of whether they have been imported from the master library or were pre-existing.

Step Ten: the newly edited spreadsheet with table can be republished to the master library for sharing with other users.

Step Eleven: the spreadsheet or portions thereof is actually shared with other users.

Step Twelve: the user can then go to the master library and browse for cells and tables he or she just created or modified and will find them in the master library by action of the Excel plug in working on the client computer to parse the newly created workbook and upload its primitives into the master library.

### More Detailed Description of a Process to Create a Spreadsheet using Primitives from the Master Library

Referring to FIG. 3, there is shown a screenshot illustrating the first step in a process of using an embodiment of the invention to create a new spreadsheet using the primitives master library to import primitives into the spreadsheet. In this particular example, the user decides to do a spreadsheet having a table summarizing Oracle License Usage. In the first step of the process, the user, opens Exel (or some other spreadsheet in other embodiments) and opens a blank spreadsheet page. In the illustrated example, the user places the cursor at an insertion point at cell B2. The user then decides to look for tables created by others and which are stored in the master library. He decides to look for a “summary of Oracle License Usage” table.

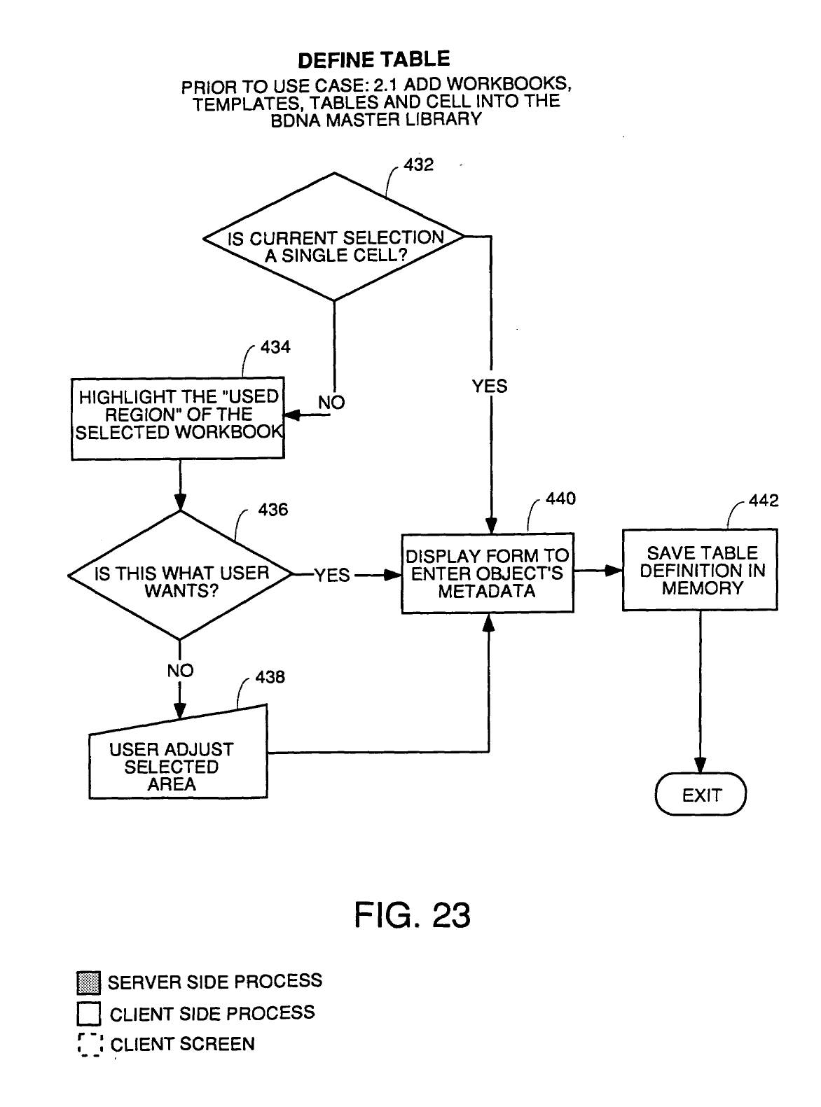

FIG. 4 is a screenshot of what the user sees when he clicks on the BDNA menu option shown at 21. This menu option is not native to Excel and has been added to the menu structure of the Excel application by integration of the Excel add-in. In alternative embodiments, other spreadsheets can be used other than Excel to which access to the source code is available, and the functionality to be described below of the menu options under BDNA menu header 21 can be implemented by modifying the source code of the spreadsheet (the same would be true for Excel if access to the source code was available). The Excel add-in which implements functionality of the BDNA user interface (21 in FIG. 3 and 23 in FIG. 4) can be implemented in any way that provides the functionality of the menu options of menu 23 in FIG. 4.

In the preferred embodiment, the Excel add-in is one or more objects in the object oriented programming sense which are integrated into the Excel application using OLE or COM integration technology which is well known in the prior art. Basically, the COM interface provides interface mechanisms for objects that implement some functionality that are to be integrated into the objects of another application which supports the COM interface. The objects of the add-in communicate with the objects of the host application Excel through the COM interface to present the menu options shown in FIG. 4. When the user clicks on the BDNA menu option, a drop down menu with four options appears: Open Master Library, Refresh Workbook, Save Workbook to Master Library and Share Workbook. These menu options are illustrative and not exclusive. Other options may exist in other embodiments.

The Open Master Library and Refresh Workbook options are discussed below. The Save Workbook To Master Library option 33 causes the primitives in the workbook to be parsed, automatically named (with user prompts to provide some name information in some embodiments) and sent to the master library for saving. This option does not cause the primitives uploaded from the spreadsheet to be saved in a way that allows other users to download the primitives into their spreadsheets. That is the function of the Share Workbook menu option 35. The primitives are cells, tables, formulas etc. as defined in the definition of objects given above in the summary of the invention. The Share Workbook menu option 35 causes the Excel add-in to save the primitives of the spreadsheet to the master library in such a way that the primitives can be downloaded into other user's spreadsheets. The “Save workbook to master library” menu option 33 is one example of a user interface mechanism of a graphical user interface variety.

When the user selects this menu option to save the workbook, in one embodiment, the client side add-in process and the server side master library process combine to save the spreadsheet upon whose command bar the menu option is displayed and parse its individual objects and save them. As part of this process, the workbook and its individual objects are converted into descriptions for transmission over any data path such as a LAN to the server. In the preferred embodiment, the description of each object is an XML description, and the data path is a local area network.

The menu option Refresh workbook 26 in FIG. 4 is an option the user can use to refresh the values in her (user #1) spreadsheet for cells, tables or formulas that have been imported from the master library (also known as the master library) and which were imported into the master library from another person's (user #2) spreadsheet. This menu option is useful when user #2's data has changed such that cell values, data inputs to the formula stored in a cell or the content of a table which was uploaded into the master library and downloaded into user #1's spreadsheet has changed since the primitive was first imported from the master library into user #1's spreadsheet.

To start the process of adding a primitive from the master library to a spreadsheet under construction, the user clicks on BDNA and selects the Open Master Library option 25. This causes a new window to open titled BDNA Master Library shown in FIG. 5. This window displays user interface tools by which the user can specify a search through the contents of the BDNA Master Library and is where the primitives uploaded from spreadsheets of other users are stored.

FIG. 5 is a screenshot of a typical display which the Excel add-in causes to be displayed when the Open Master Library Option is selected. The menu options the Excel spreadsheet plug in adds to the Excel host application are dialog boxes 29 and 31 to specify what type of primitive the user wishes to locate in the master library and the type of search to use such as text search, advanced search or browse. The user can browse by functional area or owner when doing the search, as shown by user interface tool 27. Dialog box 29 allows the user to specify that the search is for cells, tables, workbooks or templates. Tables are selected for this example. Dialog box 31 allows the user to specify the type of search: text search; advanced search or browse.

Area 27 in FIG. 5 allows the user to specify searches by functional area or owner.

The primitives in the master library have metadata associated with each which categorizes it as having come from some particular user or owner and which functional area the primitive applies to such as sales and marketing, accounts receivable, accounts payable, IT management, etc. In some embodiments, searches for primitives can also search for primitives with particular metadata. For example, suppose, a user is interested in SAP licenses, and selects cells option 39 in dialog 29 and selects text search option 37 in dialog 31 and makes the search term SAP. A text search will return all the cells in the master library which have SAP somewhere in the name or keywords of the cell as indicated by the metadata. The advanced search option 41 allows searches of the metadata of the primitives with more sophisticated search criteria. For example, a search can be performed which specifies, “Give me all the cells created between date X and date Y where the owner is Constantin” or “Give me all the cells that are highlighted to yellow in Excel”. The advanced search allows the user to search based upon Boolean logic combinations of metadata where the metadata which can be searched is both metadata captured by the Excel add-in and metadata captured by Excel itself.

The user can also choose the Tables option 45 or the Templates option 47 in dialog 29 as the type of primitives to search using whatever option is chosen in dialog 31.

Each of dialogs 29 and 31 has an upper area 49 and 51, respectively where the selected option is displayed. FIG. 5 shows that the user has chosen to search the Tables primitives by the Browse search option.

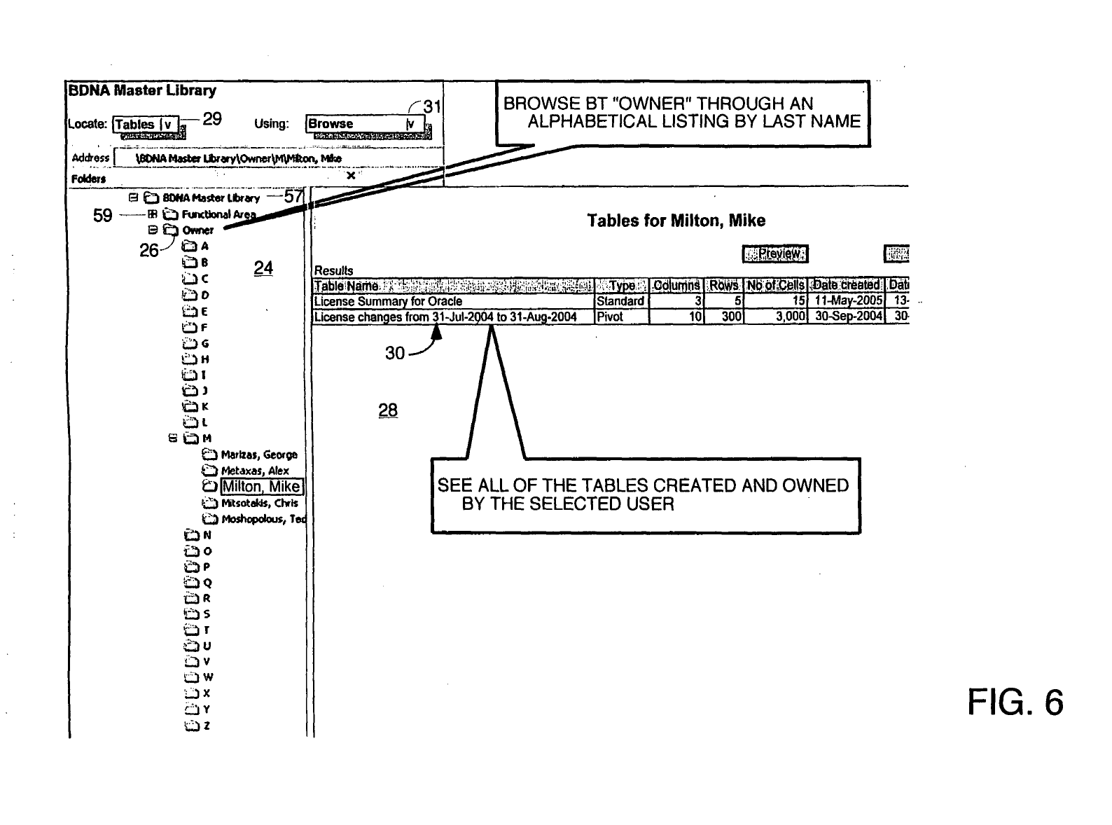

The Browse search option 43 allows the user to browse the primitives stored in the master library in a tree structure. The tree structure will be organized by functional area if option 53 is selected in are 27, and is organized by owner if option 55 is chosen in area 27. This is illustrated in FIG. 6 below.

Referring to FIG. 6, there is shown a screenshot of a screen which is displayed when the user chooses to search by owner using user interface tool 27 in FIG. 5 (instead of by functional area) for primitives in the master library. In FIG. 6, a navigation pane 24 appears on the left side of the screen showing a BDNA Master Library folder 57 which contains a Functional Area folder 59 and an Owner folder 26. The user has chosen to browse the Owner folder as indicated by the minus sign next to the folder icon which means that the individual contents of the folder are displayed under the Owner folder in the navigation pane 24. Under the Owner folder 26 there appears in the directory structure a new layer of folders, each named with one letter of the alphabet. Each Lettered Folder contains subfolders in the directory structure, one for each owner having a primitive stored in the master library whose last name starts with the letter of the Lettered Folder. Folder M has been expanded to illustrate this concept. Folder M contains five subfolders, each named after a different author. A folder for a user named Mike Milton is shown as having been selected as indicated by highlighting (as indicated by a box around the folder name). The user has selected to browse the primitives in the form of tables created by Mike Milton and chosen for sharing.

This user choice has caused a content pane 28 to be opened on the right side of the screen when the user selected Mike Milton's folder. In that content pane, there is displayed a table 30 listing all the names of table primitives that Mike Milton has authored and has chosen to share. Also displayed in this table listing of table primitives Milton has created are the type, number of columns, the number of rows, the number of cells, the date created and the date modified. This table can be used by the user to pick a table from the master library to upload to his spreadsheet.

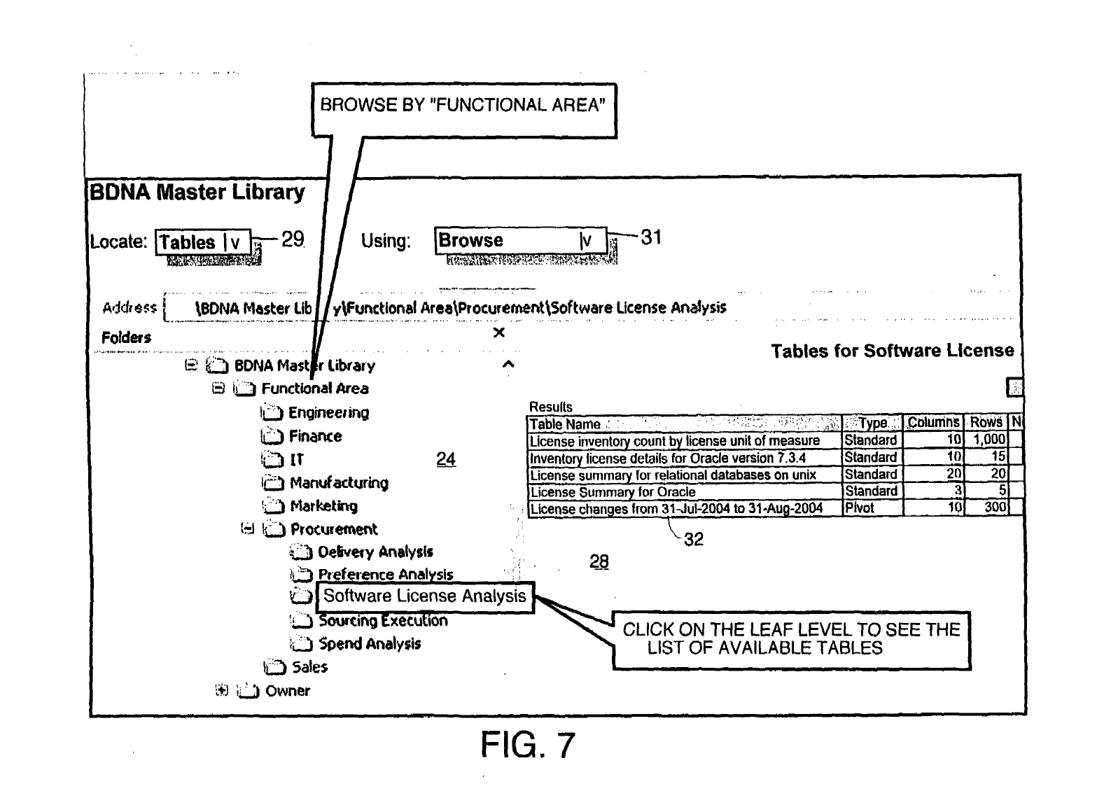

FIG. 7 is screenshot of a screen which appears in the preferred embodiment when the user chooses in area 27 of FIG. 4 to browse in the master library by functional area. In this particular example, the functional area “Procurement” has been chosen, and the user has chosen the Software License Analysis functional area within the procurement area. This means that the user wants to see all the tables in the master library displayed by the Software License Analysis functional area. These tables will be displayed in the content pane 28 on the right side of the screen when the user clicks on the Software License Analysis leaf level. Other functional areas in which primitives are stored and can be searched are: engineering, finance, IT, manufacturing, marketing, and sales.

The primitives stored in the master library are organized into functional areas based upon questions the author answers when he chooses to share the primitives in the spreadsheet with other users. The user just indicates which functional area of the company the spreadsheet primitives should be stored in, and that information is stored in the metadata of all the primitives extracted from the spreadsheet when they are stored in the master library. In some embodiments, the user defines where each primitive is stored by so indicating, and in other embodiments, all the primitives from the worksheet are stored in the same functional area based upon the user's answer to the question as to where the primitives should be stored.

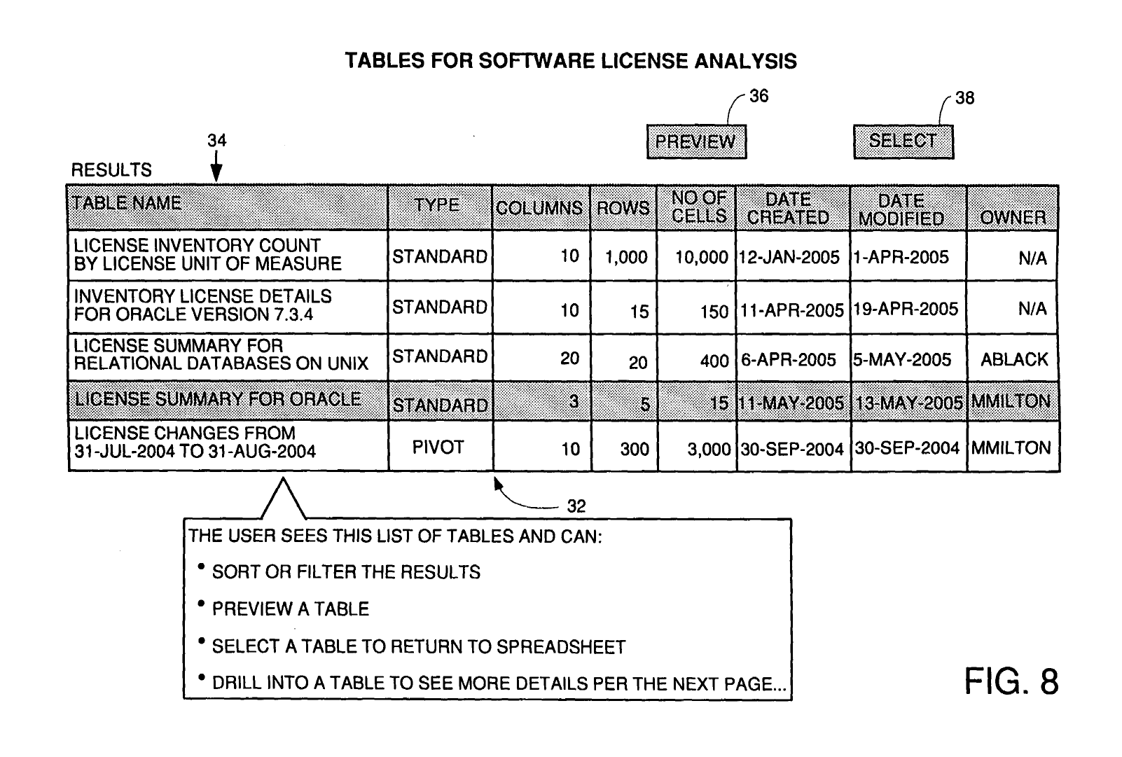

The table 32 displays all the tables in the master library that deal with software licenses and have the Software License Analysis functional area listed in the metadata. Dialogs 29 and 31 at the top of the screen repeat the selections made in dialogs 29 and 31 in FIG. 5 to remind the user what the current search is in terms of primitives being searched and the method of search. The table names in table 32 are the table names that were automatically generated by the system in order to store the primitives in the master library. The other columns in the table list the type of primitive, the number of columns and rows, the owner name as seen in FIG. 8.

FIG. 8 is a more detailed view of the table 32 of FIG. 7 which illustrates the user interface of the preferred embodiment which can be used to do more processing on the primitives returned from the search. Commands can be given to sort or filter the primitives returned in the search from the master library by date created, date modified, owner or any other of the metadata. A command can also be given to preview a particular primitive in the master library by selecting an item from the table 32 and selecting the preview command box 36 to issue the preview command. The user can also give a command to select a primitive for return to the spreadsheet under construction by selecting a primitive from the table and the selecting the Select command by double clicking (or some other indication of an intent to issue the command such a single right or left click) on the Select box 38. A command can also be given to drill down into a primitive to see more details about the primitive.

In the example of FIG. 8, the primitives shown are tables having the names listed in column 34 that the system automatically gave to the primitives. In other embodiments, the preview and select commands described above can be given in other ways such as by drop down menus, text line commands, etc. How these commands are given is not critical to the invention.

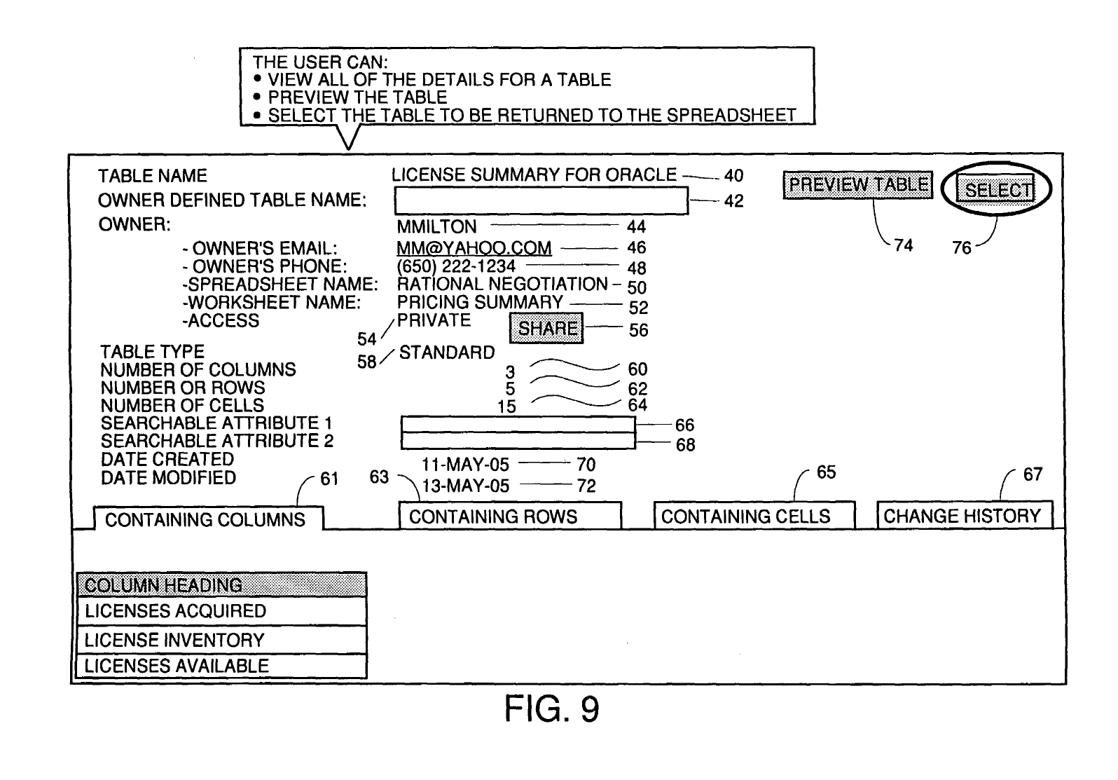

FIG. 9 is a screenshot of the type of screen which is displayed in the preferred embodiment after the user has selected a particular table in FIG. 8 and selected the preview button to view the table details. FIG. 9 displays metadata about the table or other primitive selected in FIG. 8. In this particular case, the metadata gives: the table name for the primitive given by the system at 40; any name given the table by the user at 42; the owner of the primitive at 44; the email address of the owner at 46; the spreadsheet name from which the primitive came at 50; the worksheet name from which the primitive came at 52; whether the owner has chosen to keep the primitive private (54) or to share it by selecting the share command represented by box 56 which is a user interface widget which can be invoked to send the proper communication to the master library application to cause this particular object to be shared (as opposed to sharing the entire workbook). In this particular example, the owner has chosen not to share this primitive as indicated by the value “private” shown at 54 in the access field; the table type at 58; the number of columns at 60; the number of rows at 62; the number of cells at 64; any searchable attribute filled in at 66; any other searchable attribute filled in at 68; the date the table was created at 70 and the date the table was modified at 72. In some embodiments, some of this metadata is automatically picked up by the Excel add-in from information entered into the user's computer operating system such as name, email and phone and date created or modified. Other metadata such as user-supplied name 42 and searcheable attributes 66 and 68 are supplied by the user.

The tabs 61, 63, 65 and 67 at the bottom of the page allow further drilling down into the details of the primitive. In this example, since a table is being previewed, these tabs are labelled with table-specific names. If a cell were being previewed, these tabs would be labelled with cell-specific names pertinent to whatever a user would want to preview about a cell. Tab 61 “containing columns” , when selected, allows the user to look at the names of the columns in the table. Tab 63 “containing rows” allows the user to preview the names of the rows in the table when selected. Tab 65 “containing cells” allows the user to preview which cells (and the formulas in those cells) are contained within the table. Tab 67 “change history” allows the user to view the history of changes made to the table by its owner. The change history is maintained for all changes made to any object and record an audit trail for all changes to any object (cell or table) to show what was changed and the date it was changed with the most recent change first.

A “preview table” command box is shown at 74 which allows the user to preview the contents of the table whose metadata is shown in FIG. 9. If the user wishes to download the table into the spreadsheet the user is working on, he or she may select the “select” command button shown at 76. This will cause the Excel add-in to send a message to the process running on the server which maintains the master library to send the primitive to the client computer. The Excel add-in will then receive the primitive and insert the primitive into the spreadsheet being constructed. There are two options discussed next for primitive insertion. When the server receives the command to send the selected object to the client computer, the object is described in an XML file (or some other suitable language) and the XML file is sent from the server to the client. At the client, the XML file is converted into a spreadsheet object and inserted into the spreadsheet at a user designated insertion point.

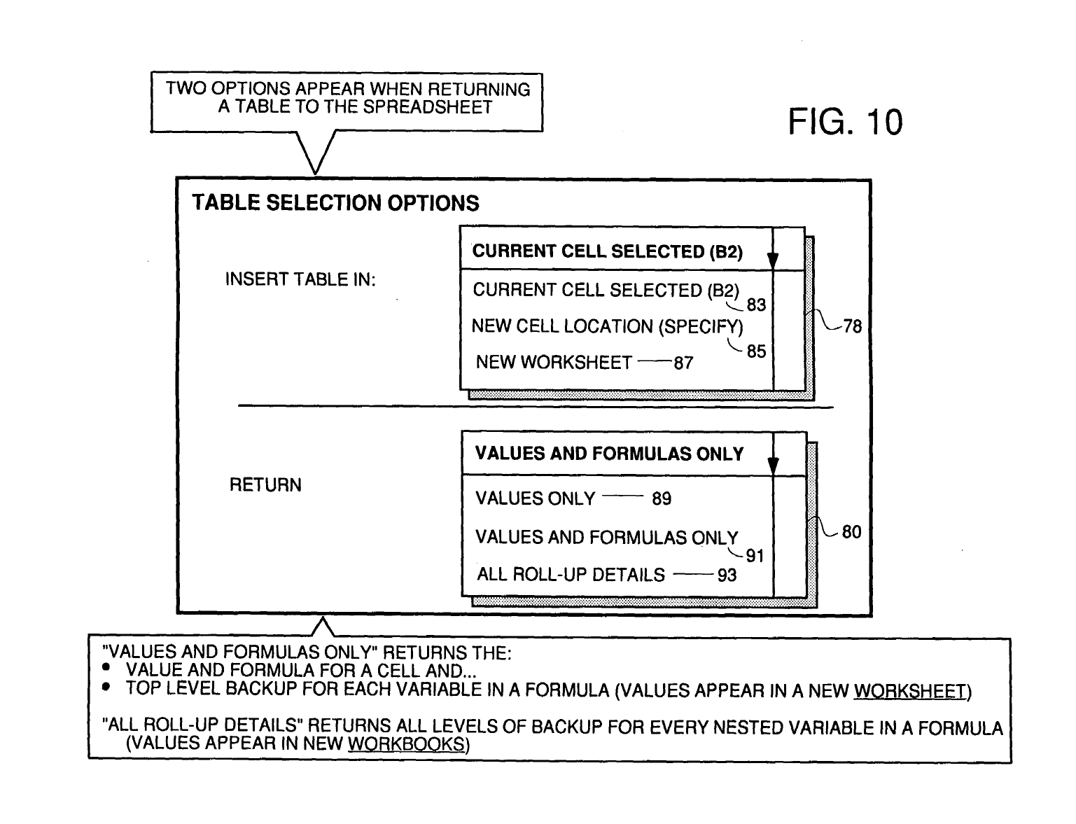

FIG. 10 is a screenshot of the options display which the Excel add-in causes the client computer to display when the user chooses to return a primitive from the master library to the spreadsheet under construction. A first dialog box 78 gives options the user can choose to select the place where the primitive is to be inserted. The choices in the preferred embodiment are: Option 1 shown at 83—the currently selected cell (shown in 3 at 81 and selected by the user) with the selected cell listed in parentheses; Option 2 shown at 85—a new cell location which the user will be prompted to specify; and Option 3 shown at 87—a new worksheet.

Dialog box 80 allows the user to specify how much of the primitive to return to the spreadsheet. Cells which have formulas programmed into them show on the spreadsheet as whatever value the formula calculates based upon the formula and its current inputs. Frequently, the formula references other cells which themselves can be programmed with formulas which themselves reference other cells. Dialog box 80 gives the user the option to return the value of a cell only (89), or the value of the cell and its formula only (91) or all the roll up details (93). The Values and Formulas only” option 91 returns the value of the cell which is placed in the workbook being built, and the formula programmed into the cell and the other object names referenced in the formula will appear. In some embodiments, those top level object names will appear in a new worksheet. The “all the roll up details” option 93 would bring in the value of the cell, its formula and all the cells referenced by the formula in the cell including their values and formulas and all the cells referenced by the formulas in the referenced cells and so on down to the end of the chain of nested cells. In other words, all levels of backup for every nested variable in a formula are returned. The values appear in a new workbook.

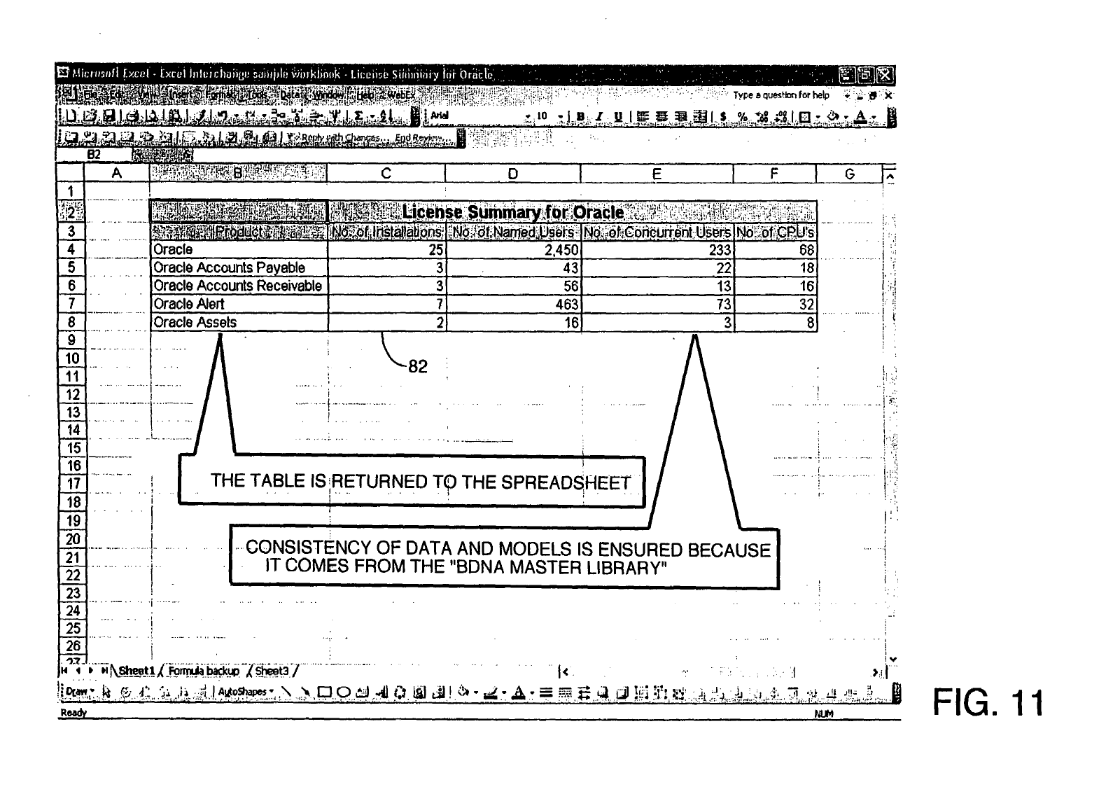

FIG. 11 is a screenshot of the client computer's spreadsheet application after a table primitive from the master library has been selected and returned to the spreadsheet under construction. The table 82 is the selected primitive which has been imported from the master library and inserted at cell B2. The name of the table and the names of the columns and rows have been inserted from the metadata. The values which are inserted into the cells are values which came from the owner's spreadsheet. A linkage or subscription is established between each cell and the original cell in the owner's spreadsheet such that when a user who has imported a cell or table gives a “refresh” comand, all the values of the cells in the imported table are refreshed to whatever values are then existing in the cells of the original owner of the table. This allows changes made by the original owner of the spreadsheet to be propagated throughout the organization for consistency, and the fact that the table is imported ensures consistency throughout the organization in calculating whatever numbers the spreadsheet calculates.

The user who has imported a primitive from the master library can use the commands of Excel to change the cell or table formulas, text, etc. after the primitive has been imported. Once the user does this, the metadata of the primitive is changed on his computer to indicate that he is the owner of the modified cell. If the user then chooses to share the changed primitive, it will be uploaded into the master library with its metadata indicating the new owner. Unless the user has changed the name, the primitive will receive the same automatically generated name when it is uploaded into the master library, but the metadata will indicate a new owner. Other users who browse the master library will then find two primitives of the same name, but listing two different owners.

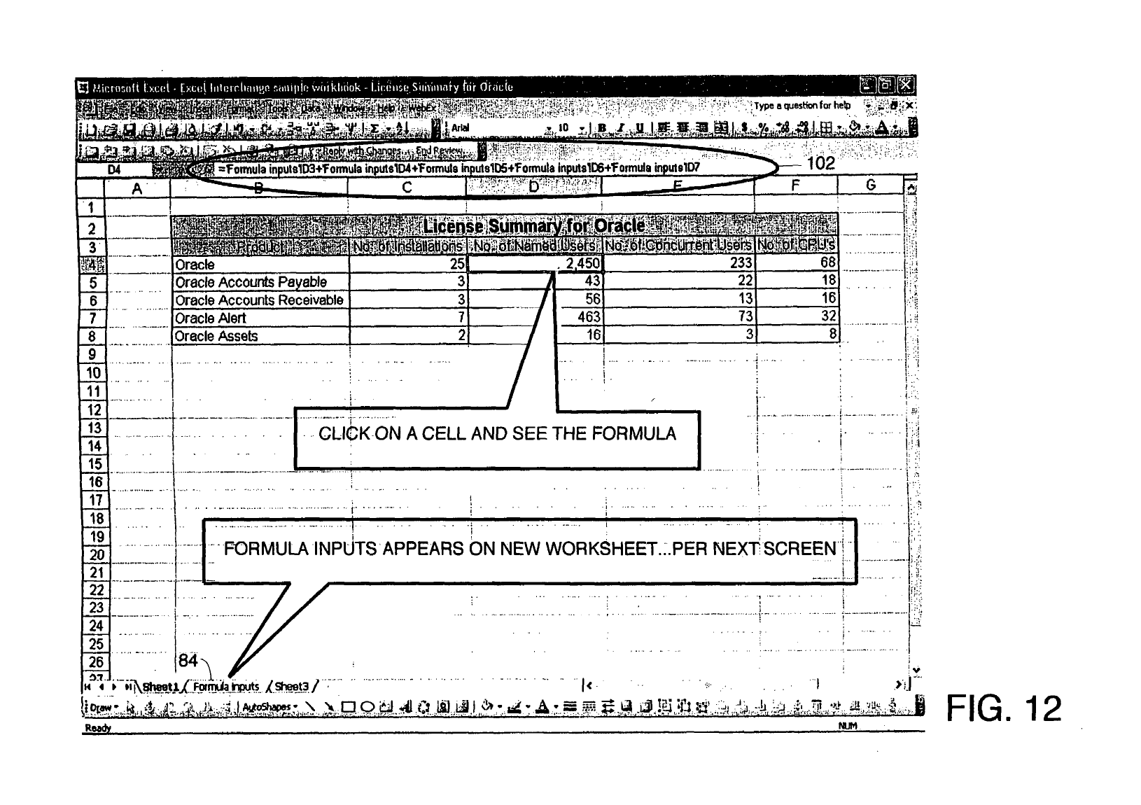

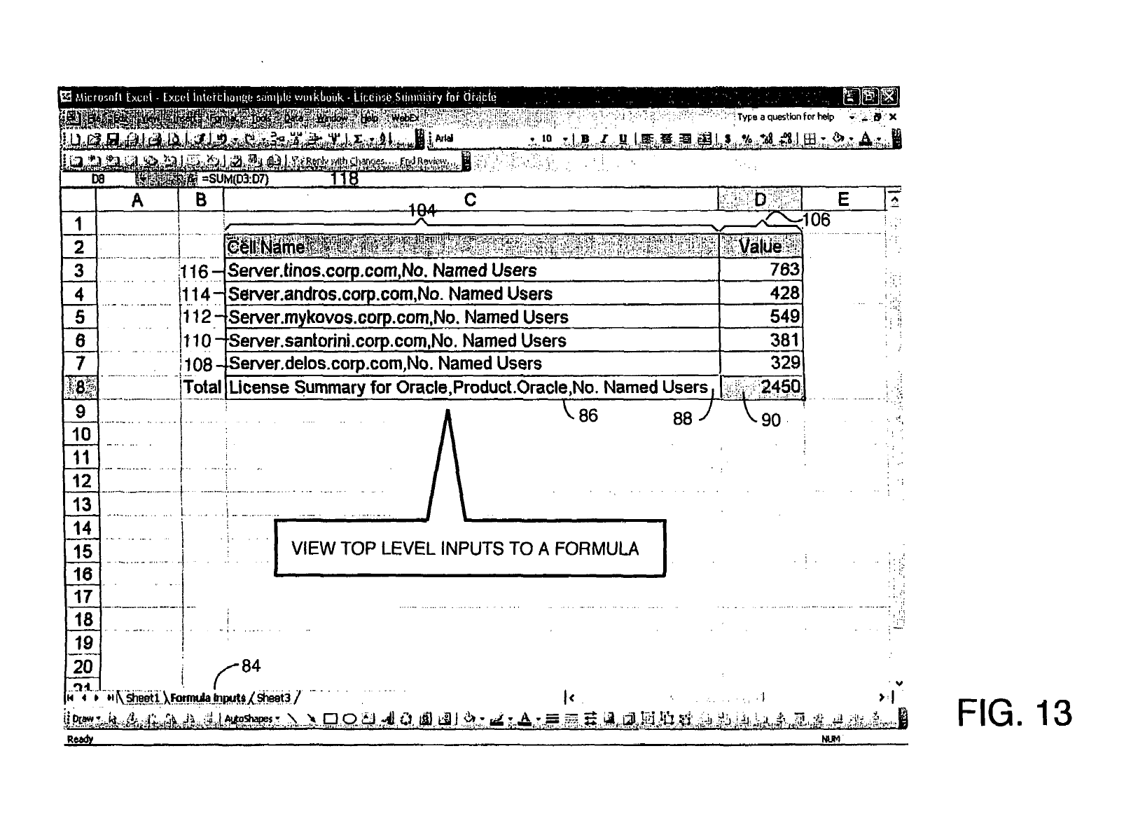

FIG. 12 is a screenshot of the display which illustrates how a user can drill down to inspect the formula behind a particular cell in the table primitive imported from the master library. In this example, the user clicks on cell D4 to inspect the formula programmed therein. Assuming the cell inputs have been imported, this action causes the Excel spreadsheet application to be controlled by the Excel plugin to cause the formula inputs to appear on a new worksheet, and causes the formula and cells which are combined to make up the total shown in the selected cell to be displayed in area 102. This formula lists the cells on the Formula inputs spreadsheet that are combined to make the total in selected cell D4 in FIG. 12, and is lists the mathematical formula dictating how the cells in the Formula inputs worksheet will be combined. In this example, cells D3, D4, D5 and D6 and D7 on the Formula inputs worksheet will simply be added. The bottom of the spreadsheet shows a tab 84 called “Formula inputs”. This is the new spreadsheet upon which the formula inputs are displayed for the selected cell. That Formula inputs worksheet is illustrated in FIG. 13.

FIG. 13 is a screen shot of the display that results when Formula Inputs tab 84 is selected in FIG. 12. Table 86 shows the automatically assigned names of the cells and their values from the original owners spreadsheet that are combined to yield the value of cell D4 in FIG. 12. The cell name automatically given the cell in the original owners spreadsheet are shown in column 104. The value of each cell in column 104 in the original owner's spreadsheet is shown in column 106. The particular cell name for cell D4 in FIG. 12 is given on row 88 of table 86 and the value for that cell is repeated at 90.

If the user originally chose to import all the rollup details of a primitive, each of the cells in rows 108, 110, 112, 114 and 116 could have other cells and/or formulas behind them. By clicking on one of the rows, the formula and cells on another Formula inputs worksheet which make up the total for the cell selected row will be shown in area 118. There will be another tab like tab 84 at the bottom of the worksheet which gives a name for the worksheet upon which the rollup details at the next level down in the hierarchy will be shown. To see those rollup details, that tab (not shown) can be selected and another display like that of FIG. 13 will be displayed which shows the rollup details of the selected cell. When all the rollup details are imported, the user who imported the primitive actually has more information than the original owner because there is a meaningful name for every cell in the heirarchy whereas the original owner only has the position of each cell and its formula.

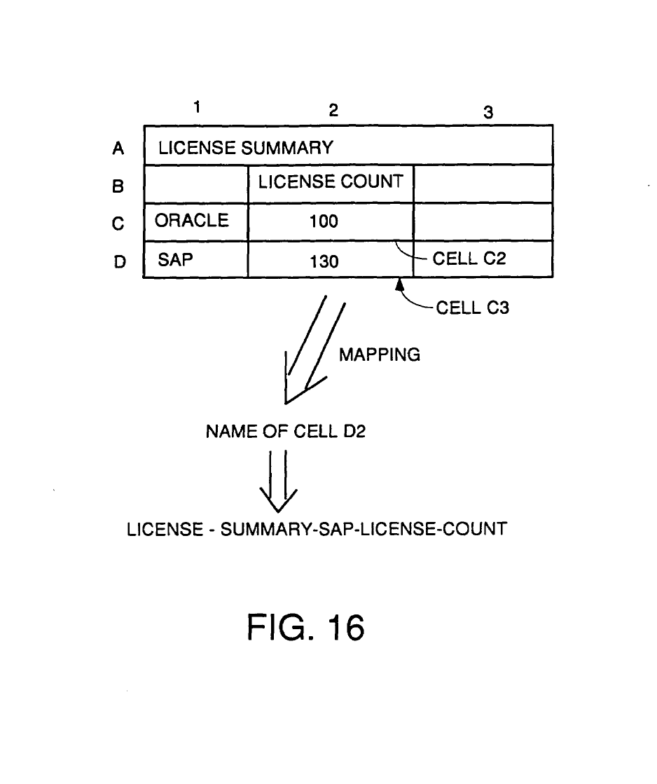

FIG. 16 illustrates an example of the automated naming of cells to map them from cell locations in the original spreadsheet from which they came (the spreadsheet being parsed) to a name automatically assigned to the cell or table by the system for use in storing the cell or table as a primitive in the master library. It is this automatic naming process which decouples the primitives in the master library from their particular spreadsheet, workbook and cell number address components in the spreadsheet from which they came. The name is only one component of the path back to the original object in some embodiments. An example of a typical heirarchical path in an automatically assigned name might be owner1.wk1.sheet1.table1.columnname.rowname. The hierarchical path embodied in the automatically assigned name is more for the end user to understand the original source of the object. In the preferred embodiment, the system automatically assigns a unique identifier to each object and maps that unique identifier to all the data needed to find that object in the appropriate workbook location of the appropriate computer on the appropriate network. Both this name (along with any path data needed and stored by the system) and the unique identifier assigned to each object can be used to retrieve the object from the master library. The rest of the path for each object in the master library is stored in the metadata of the object so that when the object is to be refreshed, the path data can be obtained from the object's metadata. In this way, the primitives can be inserted into other spreadsheets being composed from the master library and can be refreshed.

Excel is the most installed application in use today. By virtue of the ability to parse spreadsheets and store tables and cells in a master library, it is possible to allow models and details within a spreadsheet to be shared across an organization and not just share the entire spreadsheet thereby ensuring consistency across an organization.

As an example of how the automated name generation process works, suppose in FIG. 16 there is a table in a user's spreadsheet called License Summary and it contains a column called License Count. Suppose there are two rows for Oracle's license count, the value of which is 100 and is stored in cell C2 and the SAP license count, the value of which is 130, is stored in cell D2. When this spreadsheet is parsed, the system will automatically assign a name to cell D2 (as it will with all other cells also). An example of such a position to name mapping is shown below the table where the name assigned to cell C3 is License_Summary.SAP.License_Count. This name is automatically derived by the system by using the table name, the row name and the column name. Other methodologies could be used also. The important thing is that the cell name is stored in the master library and that name can be mapped to the particular position in the original spreadsheet where the cell is found. The applicant's are unaware of any prior art system which can parse spreadsheets at this time to identify and save the individual objects of a spreadsheet in a master library. This allows individual objects to be downloaded from the master library to a client computer. The applicants are also unaware of any prior art system which automatically generates names for the primitives parsed out of spreadsheets.

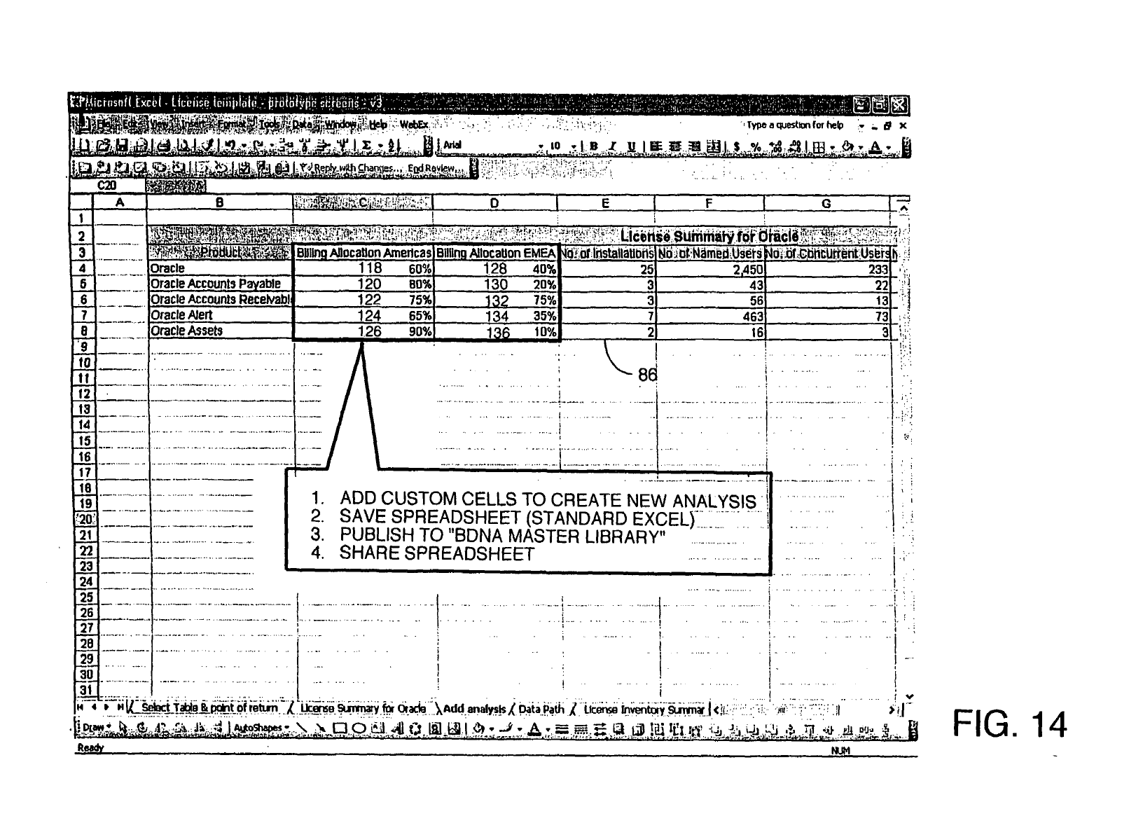

FIG. 14 is a screen shot of the display that results when the user chooses to add custom cells to a primitive that has been downloaded from the master library. The user can choose to add new custom cells to create new analysis. Adding custom cells to a primitive imported from the master library is done using standard Excel commands, and the process works as if the primitive had been built from scratch by the user. In the example of FIG. 14, the cells 118, 120, 122, 124, 126, 128, 130, 132, 134 and 136 are custom cells added to the primitive 86 imported from the master library. The metadata of each of these cells will indicate the owner as the user who authored the custom cells.

After modifying the imported primitive, the user saves it just like any other spreadsheet. The user can also choose then to publish the modified primitive to the master library which will cause the cells and tables etc. in the spreadsheet to be uploaded into the master library, each with suitable metadata. The user can then choose to share the spreadsheet with other users of the master library. In some embodiments, this will cause each primitive's metadata to be altered in the master library to indicate the primitive can be shared. In other embodiments, the user can select individual primitives for sharing. Altering the metadata can be done by tracking down each primitive from the spreadsheet which has already been stored and altering its metadata, or by doing the parsing and storage of each primitive over again with the master data altered in each to indicate the primitive can be shared. Sharing of all objects in a workbook that the user owns can be accomplished by the user's selection of the share command menu option 35 in FIG. 4 (a add-in command). Sharing of individual objects in a workbook can be accomplished by viewing the object's metadata in the master library as shown in FIG. 9 and invoking the share command shown at 56.

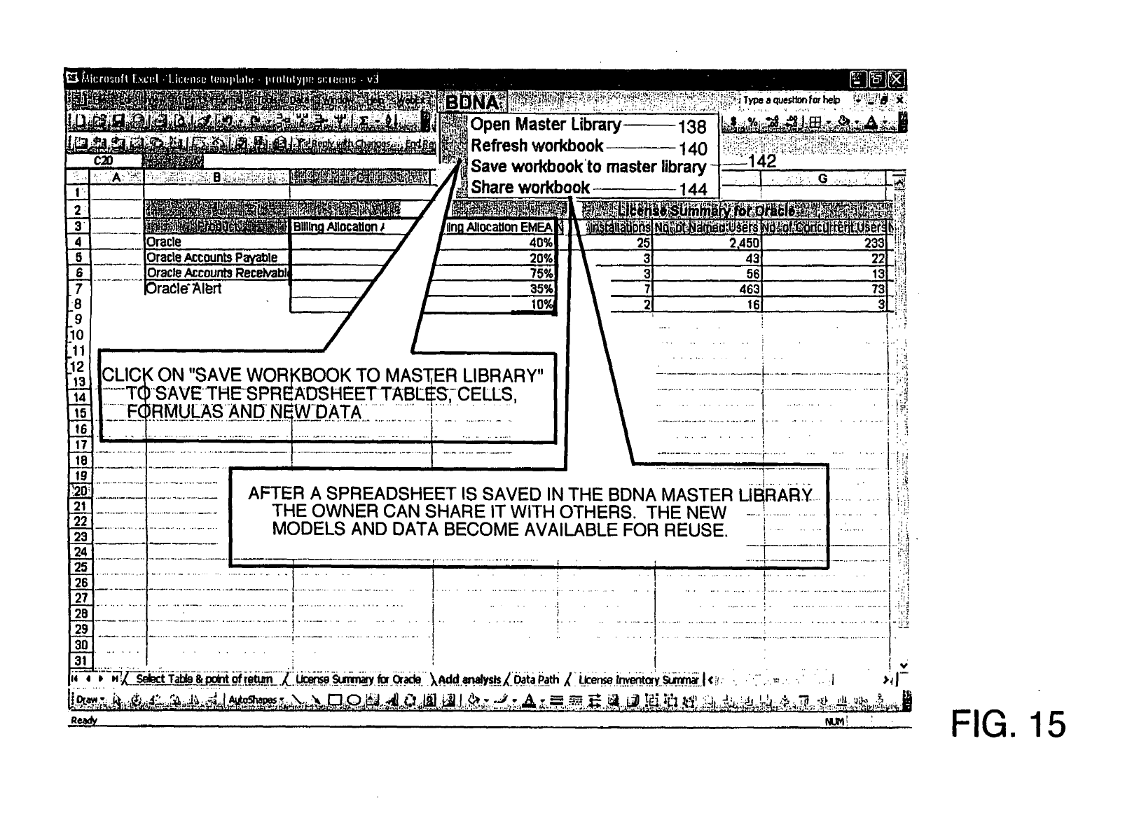

FIG. 15 is a screen shot of the user interface mechanisms implemented by the Excel plug in by which the user can give commands to open the BDNA Master Library (138), refresh the workbook, (140) save the workbook to the master library (142) or share the workbook (144). Sharing or saving the workbook to the master library saves the entire spreadsheet, each of its cells and formulas, each of its tables and any new data, new cells, new tables or any other new spreadsheet objects created by the user. The share command causes all objects stored in the master library from this workbook to have their database entries updated to indicate they can be shared with other users. The save workbook to master library command 142 synchronizes the cells, formulas, tables and data in the spreadsheet to the corresponding primitives in the master library. In other words if any cell's formula, references, constants or other data has been changed (same for other objects also) since the cell was first saved to the master library, then the master library representation of that cell or other object is updated to correspond to the latest version of that object on the client computer.

### The Functional Processing Details Behind the User Interface Mechanisms Described Above

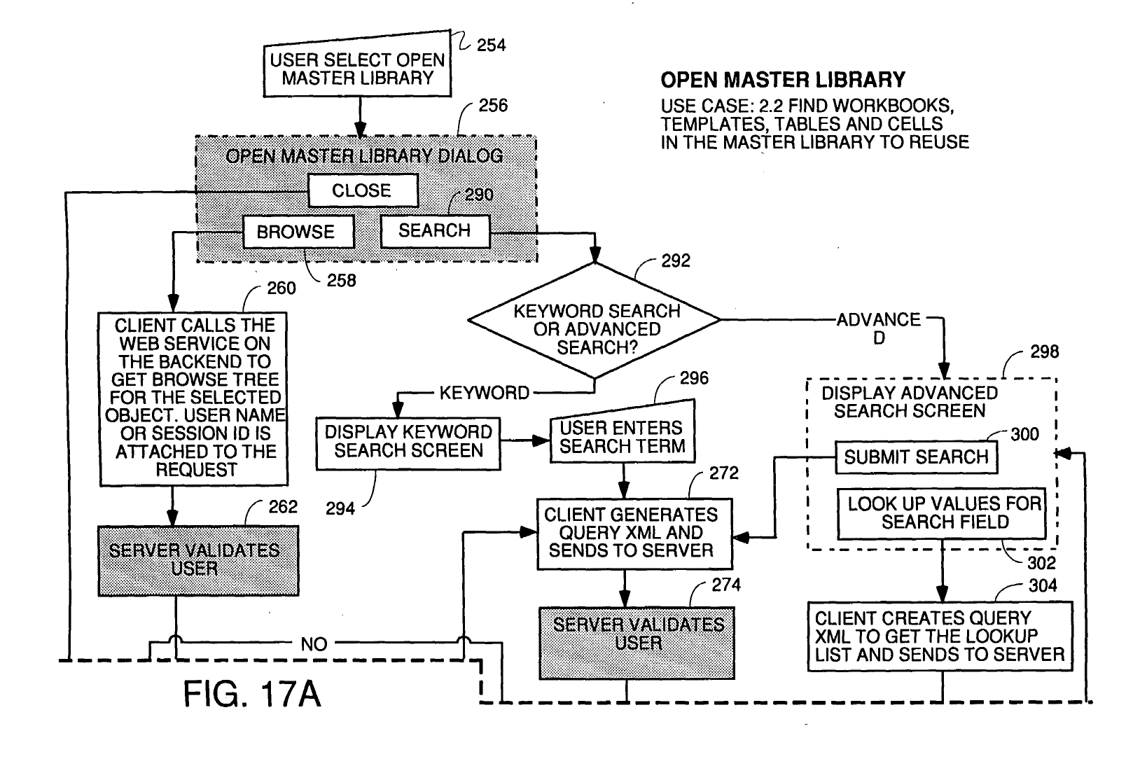

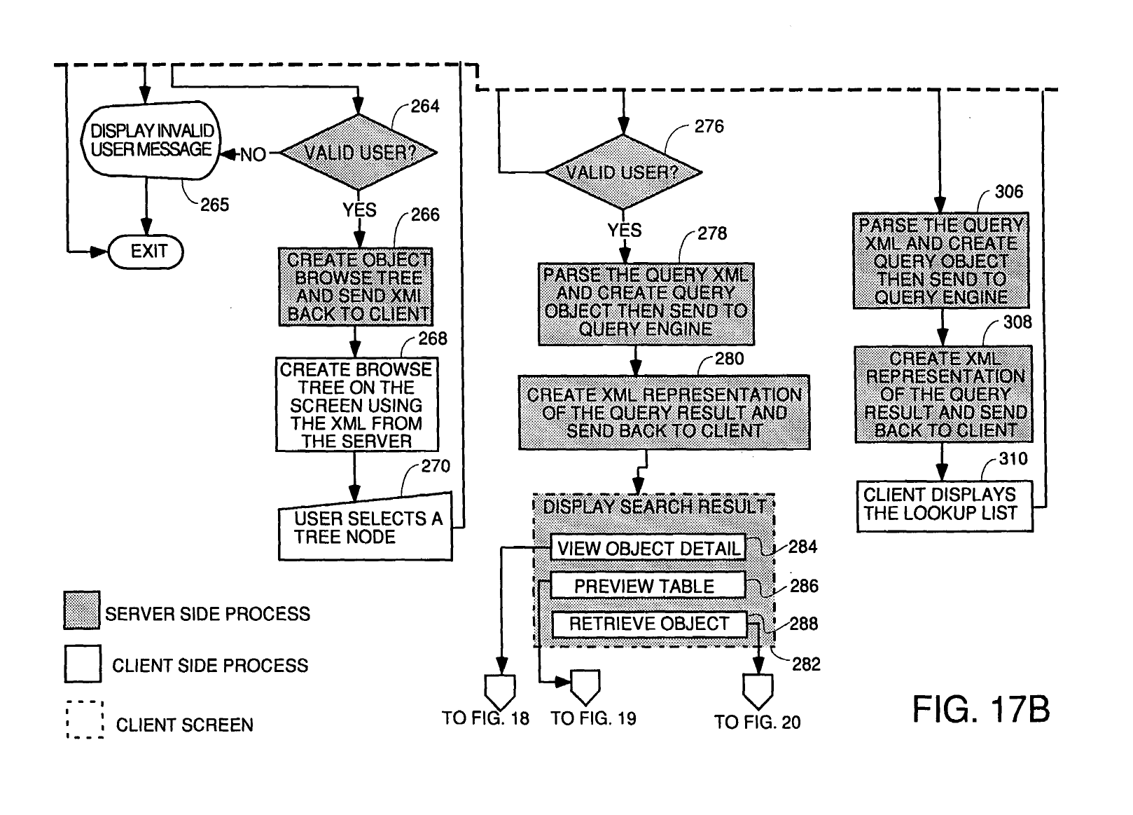

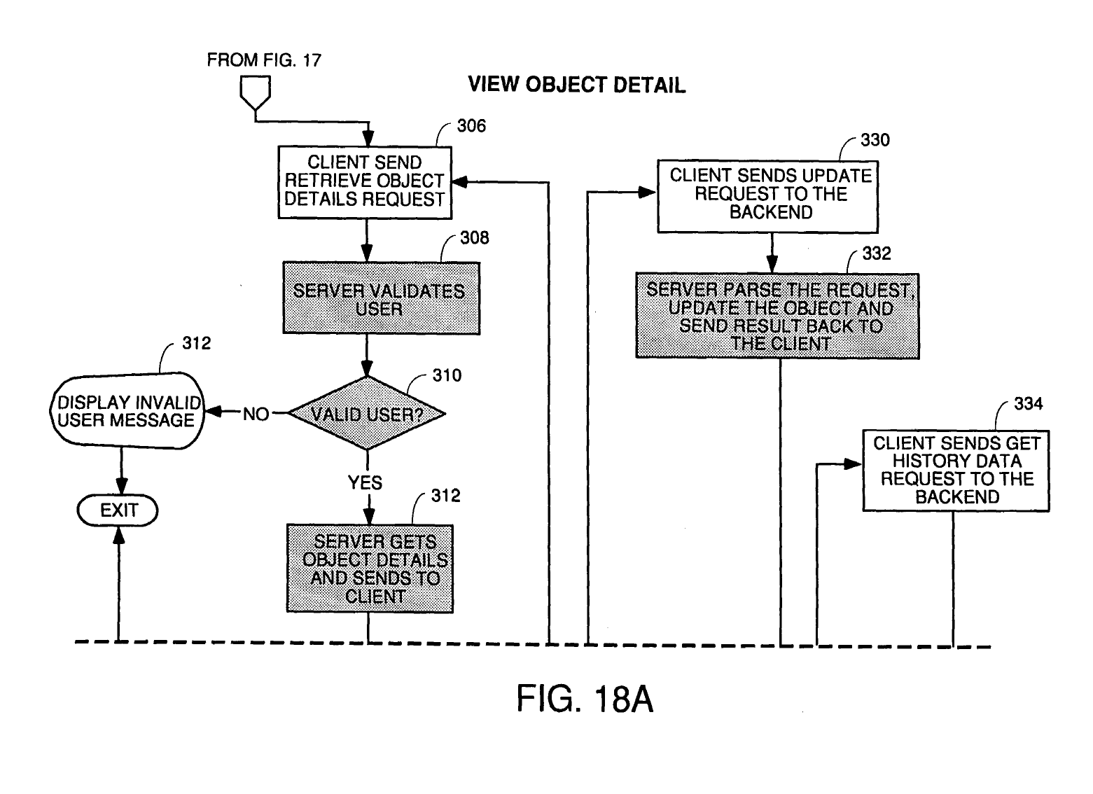

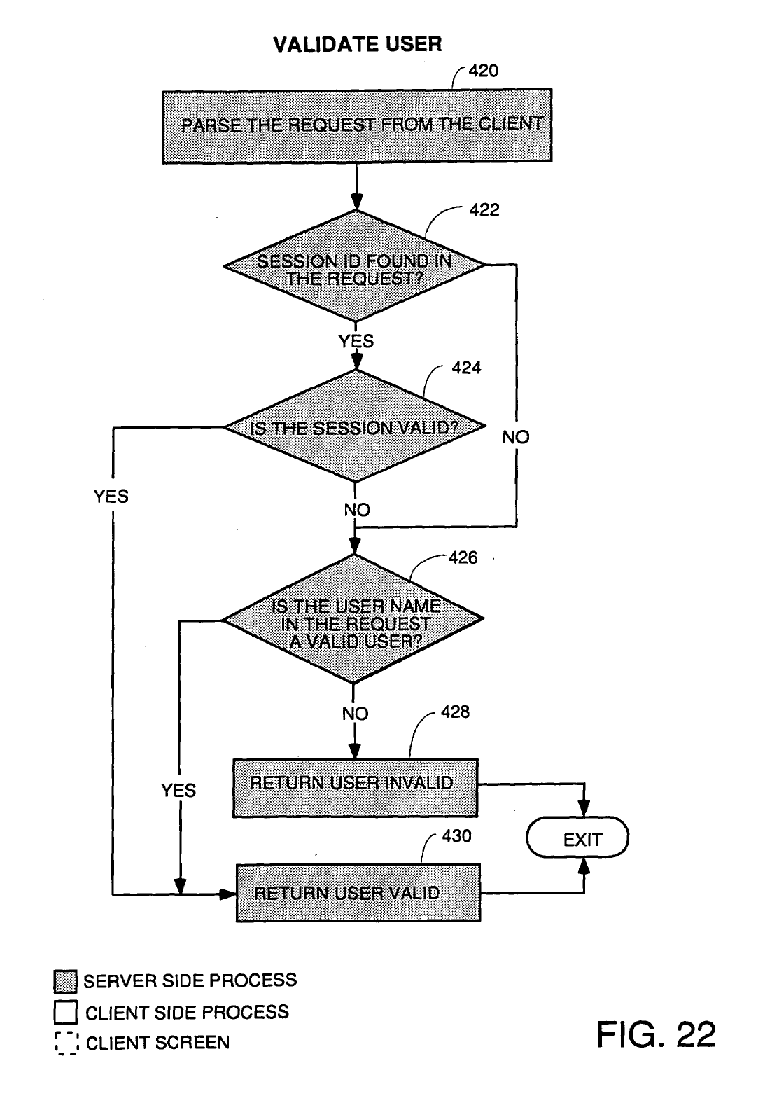

FIGS. 17A and 17B are a flowchart of the process of opening the master library and searching it. Step 254 represents the process of the user selecting the Open Master Library menu option. In some embodiments, this action causes the Open Master Library Dialog to open where choices to Browse, Search or Close are presented. If the user chooses the Browse option, step 260 is performed by the client plug in to call a web service of the backend (the backend is the server's Master Library application) to request a browse tree for the selected object type (cells, tables, templates, etc.). The user name or session ID is attached to the request so that the web service can identity to which client plug in to send back the browse tree data. The master library application validates the user according to the process of FIG. 22 and determines if the user is valid in step 264. If so, step 266 is performed by the server to create a browse tree of the objects of the requested type stored in the master library. If the user is not a valid user, step 265 is performed to display a message the user user is invalid. In step 266, an XML description of the browse tree is then created and sent back to the client plug in who requested it. The client then converts the XML description into a browse tree on the screen of the client computer in step 268.

Step 270 represents the process of the user selecting an object from the browse tree for further inspection.

In step 272, the client generates an XML query regarding the selected object and sends it to the server. In step 274, the server validates the user again (this step may be eliminated in some embodiments). In step 276, if the user is not valid, the display represented by step 265 is displayed again. If the user is valid, step 278 is performed by the server to parse the XML query regarding the object, create a query object and send it to the query engine of the master library application. In step 280, an XML representation of the query result is created and send back to the client.

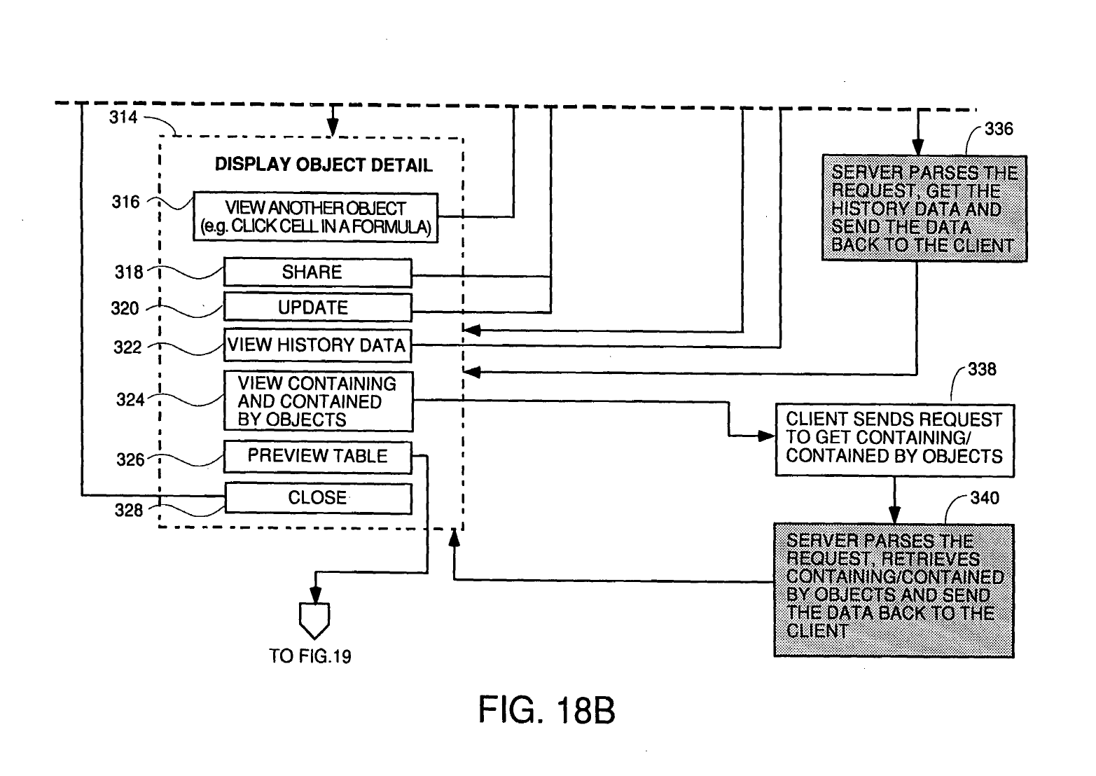

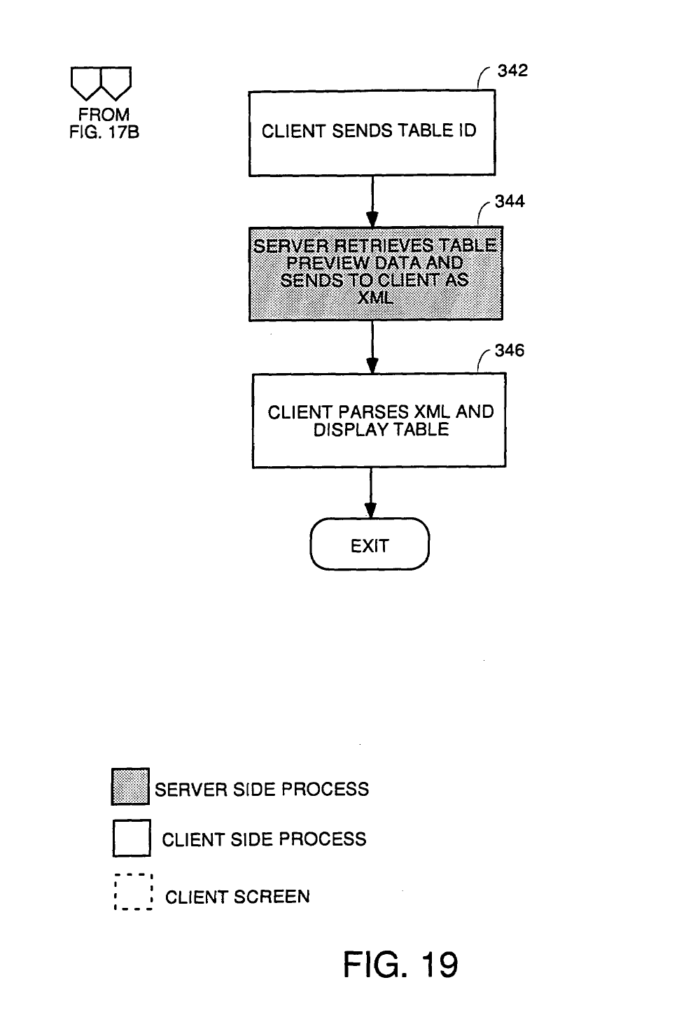

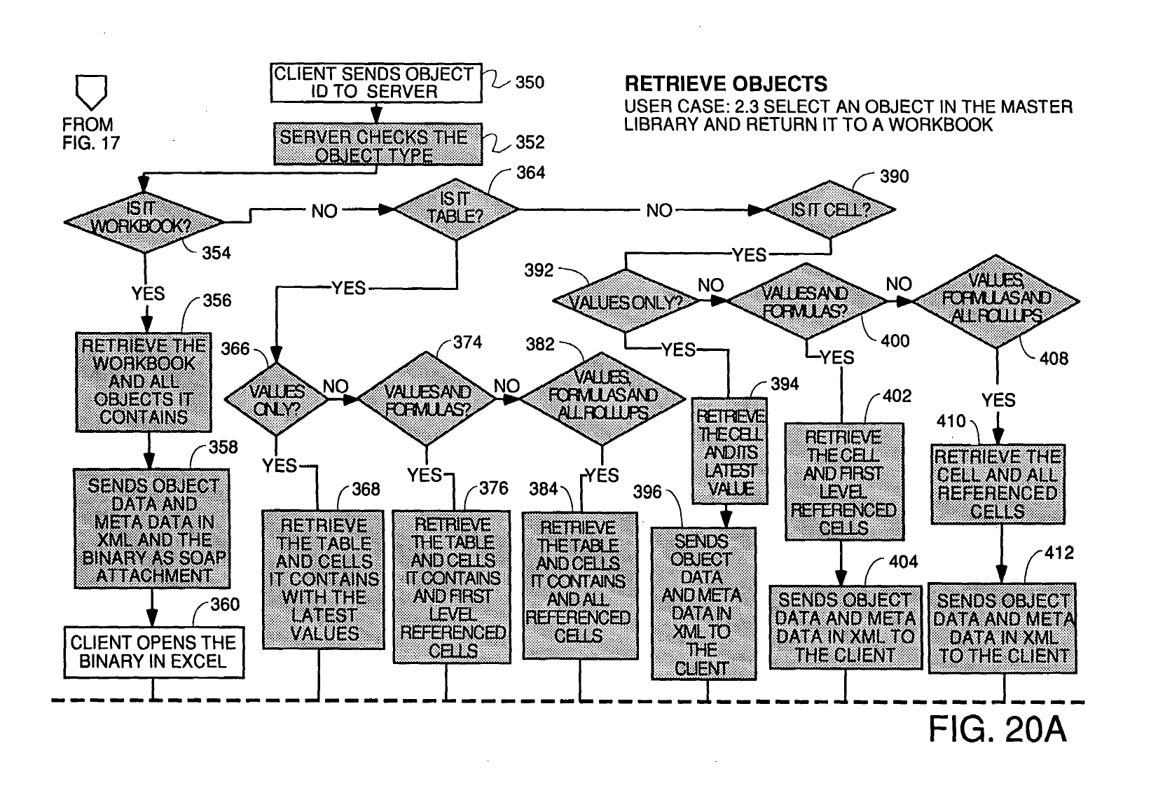

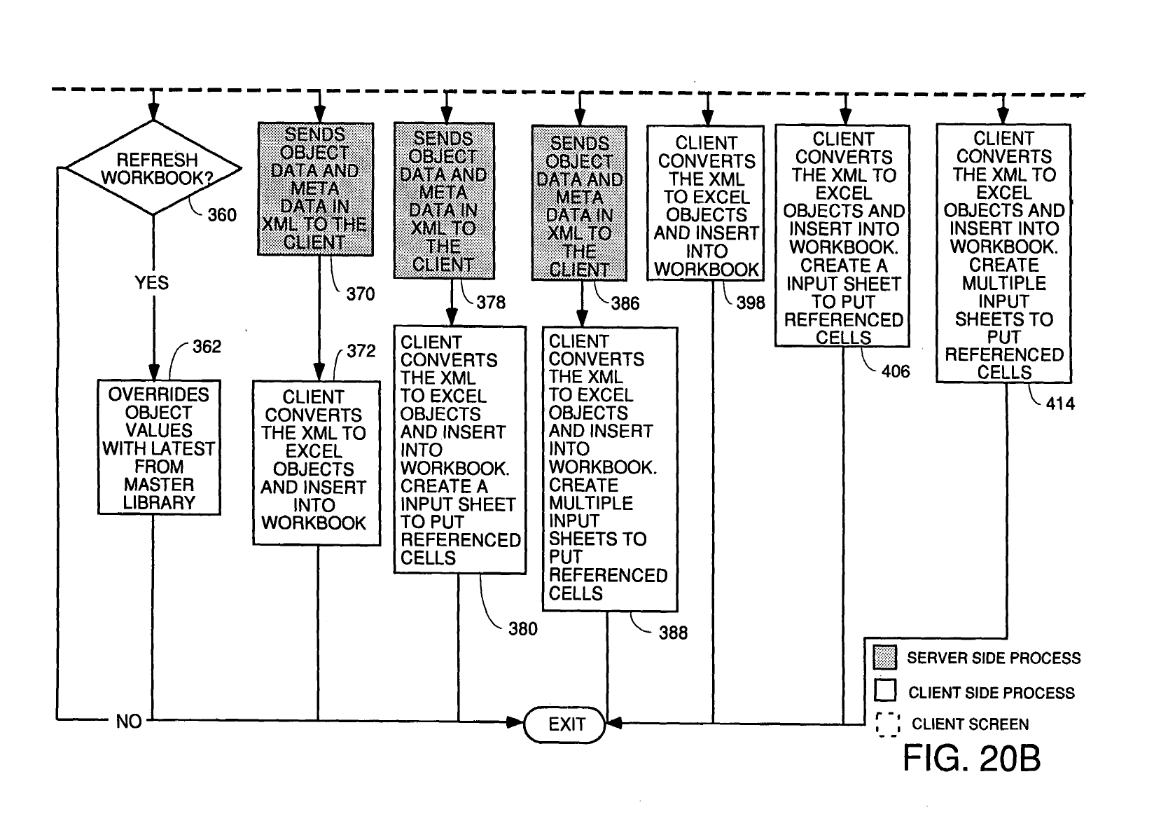

In step 282, the XML representation of the query result is converted by the client into a display which includes user interface mechanisms that can be invoked to view the objects details (284), preview the table returned by the search (286) or retrieve the object returned by the search (288). If the user chooses to view the object details, the process of FIGS. 18A and 18B is performed. If the user chooses to preview the table, the process of FIG. 19 is performed. If the user chooses to retrieve the object into the workbook open on the client computer, the process of FIG. 20a and 20B is performed.

Returning to step 256, if the user chooses the search the master library by invoking the user interface mechanism represented by box 290, step 292 is performed to produce user interface mechanisms on the client computer to determine if the user wants to do a keyword search or an advanced search. If the user chooses to do a keyword search, the client plug in performs step 294 to display a keyword search screen. In step 296, the user responds by entering a keyword search term, and processing then proceeds to steps 272 through 282 as previously described. If the user chooses to do an advanced search, step 298 is performed in the client to display an advanced search screen. The user then fills in the advanced search criteria on whatever user interface mechanism is chosen and submits the search (300). The user can also choose to lookup values for the search fields in step 302. If she does this, step 304 is performed in the client to create a query XML to get the lookup list and that query XML is sent to to the server. The server in step 306 parses the query XML and creates a query object and sends it to the query engine. In step 308, the server creates an XML representation of the query result and sends it back to the client. In step 310, the client uses the XML representation of the query result to display the lookup list. The user can then use the lookup list to compose the advanced search and submit the search in step 300.

Returning to step 284, processing to view the object details will be described next with reference to FIGS. 18A and 18B.

FIGS. 18A and 18B are a flowchart of the process of viewing object details of objects stored in the master library. In step 306, the client sends a retreive object details request to the server. The server validates the user in step 308 and 310 and displays an invalid user message in step 312 if the user is not valid. If the user is valid, the server gets the object details in step 312 and sends them to the client. In step 314, the client plug in displays the object details and displays user interface mechanisms that can be invoked to: 1) view another object 316; 2) share the viewed object 318; 3) refresh the object 320; 4) view the history data of the object 322; 5) view the containing and contained by objects of the selected object 324; 6) preview the table 326; 7) or close the display object detail window 328. If the user chooses to share or update the object, the client plug in performs step 330 to send an update request the server master library application. The server then parses the request, updates the object and sends the result back to the client in step 322.

If the user chooses to view the history data, the client performs step 334 to send a “get the history data” request to the backend. The server parses the request in step 336 and get the history data from the master library (which records changes and stores them as a historical record). The historical data is then sent back to the client for display. If the client chooses to view the containing and contained objects, step 338 to send this request to the server is performed. The server then parses the request in step 340, retrieves the contained and containing objects from the original workbook where the object was created, and sends the data back to the client.

If the user chooses step 326 to preview the table, the process of FIG. 19 is performed. FIG. 19 is a flowchart of he process to preview a table stored in the master library. Step 342 is the client sending the table ID to the server. The server then retrieves the table preview data and sends it back to the client as XML.

Returning to FIG. 17B, suppose the user chooses to retrieve an object (step 288) after opening the master library and browsing it or searching it. That causes the processing of FIGS. 20A and 20B to be performed.

FIGS. 20A and 20B are a flowchart of the process to retrieve objects from the master library. Step 350 represents the client sending the object ID to the server. The server checks the object type in step 352, and determines in step 354 if the object is a workbook. If yes, then the server retrieves the workbook and all the objects it contains from the master library (or from the original workbook where it was created in some embodiments) in step 356. In step 358, the server sends the object data and metadata in XML and the binary as a Soap attachment to the client.

In step 360, the client opens the binary in Excel and displays the workbook. In step 360, the client presents a user interface mechanism to allow the user to choose to refresh the workbook. If the user does choose to refresh, step 362 is performed where the client requests and receives the latest object values from the master library and overrides the object values with the latest values from the master library. The program then exits.

If the object type checked in step 352 indicates the object to be retrieved is not a workbook, test 364 is performed to determine if the object to be retrieved is a table. If it is, test 366 is performed to determine if values only are to be retrieved (the current values stored in each cell or the current value of a cell calculated by a formula stored in the cell). If only values are to be retrieved, step 368 is performed to retrieve the table and cells it contains with the latest values of each cell. The cell values and the rest of the object data and meta data is then converted in step 370 to XML and sent to the client. The client converts the XML descriptions received from the server to an Excel table object and inserts it into the workbook on the client in step 372.

Test 374 is performed if test 366 determines that the user has not requested values only. Test 374 determines if the user requests values and formulas. If so, the server performs step 376 to retrieve the table and the cells it contains and the first level of referenced cells. Step 378 is the server sending object data and meta data in XML to the client. In step 380, the client converts the XML descriptions of the table data, metadata, cell values and formulas, etc. into and Excel table object and inserts it into the workbook on the client. During this process, the client add-in creates an input sheet in which to put the referenced cells.

If in step 374, it is determined that the client has not requested values and formulas, then test 382 is performed to determine if the client wants to import the cell values, formulas and all rollup data. If so, then the server performs step 384 to retrieve the table and cells it contains and all referenced cells. That generally is done in some embodiments by carrying out the retrieve operations from the master library, but it can also be done by retrieving this information from the workbook where the table was originally created thereby getting the most recent data for the table. In step 386, the server sends the retrieved object data and metadata in XML form to the client. The client, in step 388, converts the XML description of the table object into an Excel table with all the formulas and rollup values and inserts it into the workbook on the client. Multiple input sheets are created on the client workbook into which are stored all the rollup values.

If tests 354 and 364 indicate the object to be retrieved is not a workbook and not a table, test 390 is performed to determine if the sought object is a cell. If so, test 392 is performed to implement user interface mechanisms to query the user to determine if the user wants to retrieve only the value of the cell. If only the cell value is sought, the server performs step 394 is performed to retrieve the cell and its latest value. Then the server performs step 396 to send the object data and metadata in XML form to the client. The client then converts the XML description of the cell into an Excel object and stores it in the workbook.

If test 392 determines that the user does not want values only, test 400 is performed by the server to determine if the user wants both values and formulas. If so, step 402 is performed by the server to retrieve the cell and its first level referenced cells in the formula programmed into the cell. The server then performs cell 404 and sends object data and metadata for the retrieved cell in XML to the client. The client then performs step 406 to convert the XML description to and Excel cell object with the same value and formula and inserts that object into the worksheet.

If test 400 determines that the user does not want just the value and formula of the cell, test 408 is performed to determine if the user want the value, formula and all rollup details. In some embodiments, this test 408 can be eliminated where there are only three choices for the level of detail desired so that if the answer in test 392 is no and the answer to test 400 is no, the processing proceeds directly to step 410 on the assumption that the user wants the value, formula and all the rollup details of the cell. In step 410, the server retrieves the cell and all the cells referenced in the formula of the cell and the formulas of referenced cells down to the lowest level of the hierarchy. Step 412 is then performed to send the object data and metadata in XML to the client, which converts the XML to an Excel cell object in step 414 and inserts it into the workbook and creates multiple input sheets into which the referenced cells are put.

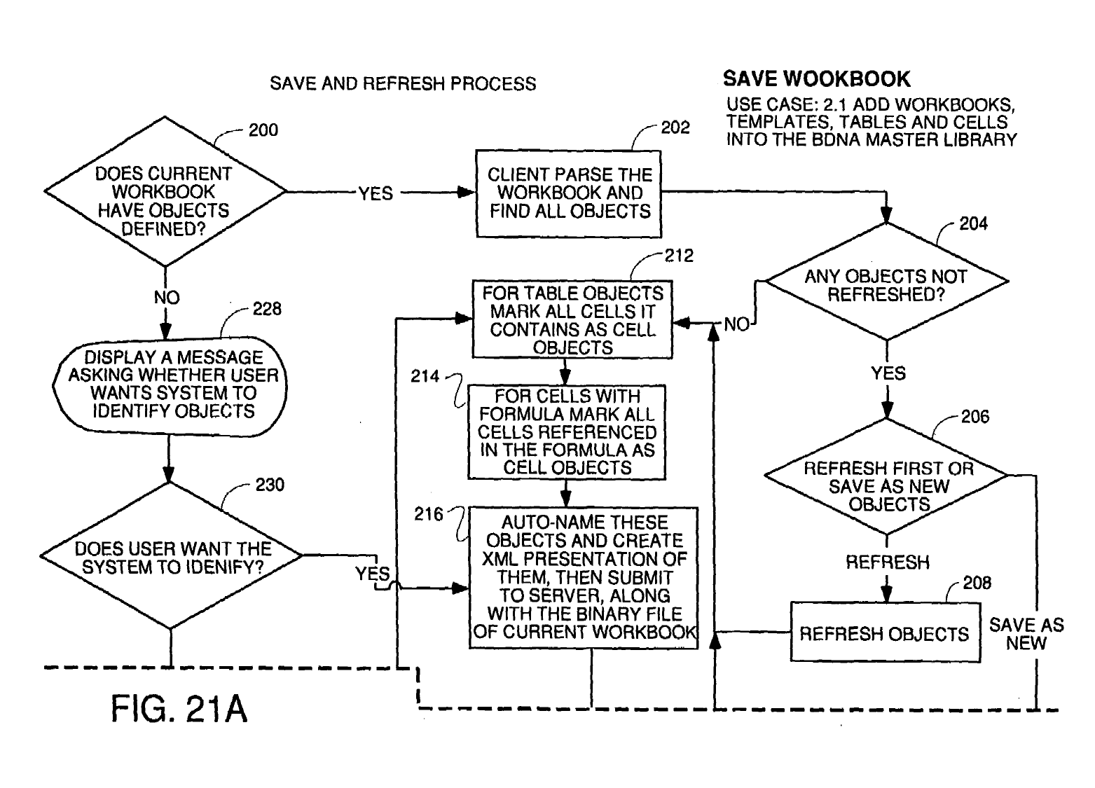

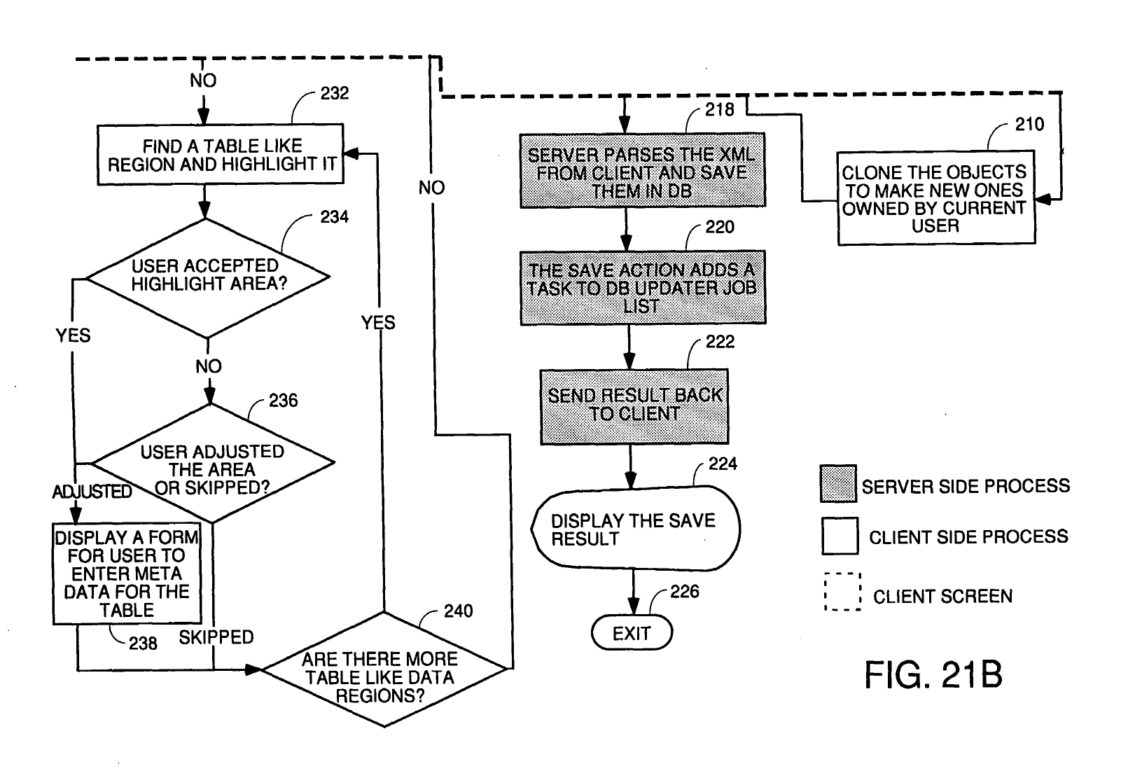

In FIG. 4, if the user chooses menu option 33 to save the workbook to the master library, the process of FIGS. 21A and 21b is performed. The process starts out with test 200 which determines if the workbook which the user wishes to save has objects already defined in it. If so, step 202 is performed to find all the objects in the workbook. Then step 204 is performed to determine if any of the found objects has not been refreshed. Because this process can be performed on a spreadsheet which contains objects which have been imported from the master library, it is possible that an imported object has been changed by its owner/creator after the object was imported from the master library. If an object is found which has not been refreshed, step 206 is performed to determine if the user wants to refresh the object to its most current state or store it as a new object. If the user chooses to refresh the object, step 208 is performed to refresh the object to the current state it is in on the spreadsheet of the owner who created it. If the user chooses to store the object as a new object, step 210 is performed to clone the object and store it in the master library as a new object owned by the owner of the spreadsheet that imported the object from the master library.

If in step 204 it was found that all parsed objects are in their most current state, step 212 is performed to mark all cells contained in table objects as cell objects. Then step 214 is performed for cells with formulas to mark all cells referenced in the formulas as cell objects. Step 216 is then performed to auto-name each object and create an XML description of the object and submit the XML description to the master library process of the server along with the binary file of the current workbook that describes the entire workbook. This binary file is stored in the master library program.

The server runs an application which implements a master library central repository. This master library application emulates the backend processing of an Excel or other spreadsheet. The master library applicaton functions to parse and calculate formulas, keep track of values, constants and formulas programmed into cells and maintain cell references in formulas and implement all the other objects and relationships between objects in a spreadsheet and stores metadata for each object received from the client machine. The master library application also maintains a mapping between each object and the original object on the client machine spreadsheet from which the object came. This allows the refresh function to be accomplished to update each object stored in the master library with the latest information from the spreadsheet on the client machine of the owner who created the object. When the server master library application receives the XML description of an object parsed from a users spreadsheet on a client machine, it decodes the description and recreates the object in the master library spreadsheet and stores all the metadata of the object, and stores a mapping to the original object on the spreadsheet of the client machine. This process is symbolized by step 218. Step 220 is the process of adding a task to the database updater list for each object just saved so that other objects that reference the object can be refreshed. Linking to the original object is done through the heirarchical name established by the client Excel add-in process and the unique user ID assigned to the object by the client Excel add-in process, in the preferred embodiment. Once the unique ID for the object and its heirarchical name are stored in the system, the link back to the original object is established. Step 222 sends an XML description of the result of the save action back to the client add-in process where the result is displayed to the end user in step 224. The process then exits in step 226.

If step 200 determines that no objects have been defined, step 228 is performed to display a message asking the user whether the user wants the system to automatically identify objects in the workbook. Test 230 determines if the user selects auto identification and naming of objects. If so, step 216 and its following steps are performed. If not, step 232 is performed to automatically find a table like region and highlight the table boundaries for inspection and approval by the user. The user is given the opportunity to accept the highlighted area or change it in step 234. The user then is given the opportunity to adjust the area included within the table. If the user adjusted the area in step 236 or accepted the highlighted area in step 234, step 238 is performed to display a form for the user to enter user defined metadata for the table. This metadata is stored in addition to the metadata automatically generated for the table by the spreadsheet. Step 240 is performed if the user skipped adjusting the size of the table to determine if there are any more table like data regions in the spreadsheet. If so, processing returns to step 232. If not, processing proceeds to step 212.

FIG. 22 is a flowchart of the process of validating a user. This process occurs at several points in the processing previously described. Step 420 represents the server side process of parsing a request from the client. Test 422 determines if the session ID is found in the request. If so, test 424 determines if the session is valid. If no session ID is found in the request, test 426 determines if the user name in the request is a valid user. If test 424 determines that the session ID is not valid, test 426 is also performed. If tet 426 determines that the user name is invalid, then step 428 returns a message to the client that the user is invalid and the program exits. If either test 424 or 426 determines either the session ID is valid or the user name is valid, then step 430 returns a message to the client that the user is valid and the program exits.

FIG. 23 is a flowchart of the process to define a table to allow a user to change the boundaries of a table on her workbook for purposes of defining the table object that gets stored in the master library. Step 432 determines if the currently selected range of cells on the user's workbook is a single cell. If not, step 434 highlights the “used region” of the selected workbook and queries the user if the highlighted region is the region the user wants to define as a table. Test 436 then determines whether the user responded affirmatively or negatively. If the user responds that the highlighted area is not the area she wants defined as a table, step 438 is performed to prompt the user to drag the boundaries of the table to the desired locations and records the results. If the user indicates in 436 that the highlighted area is the area of the desired table or drags to new boundaries in step 438, step 440 is performed to display a form to allow the user to enter metadata for the table. Finally, step 442 is performed to save the table definition in memory, and the program exits.

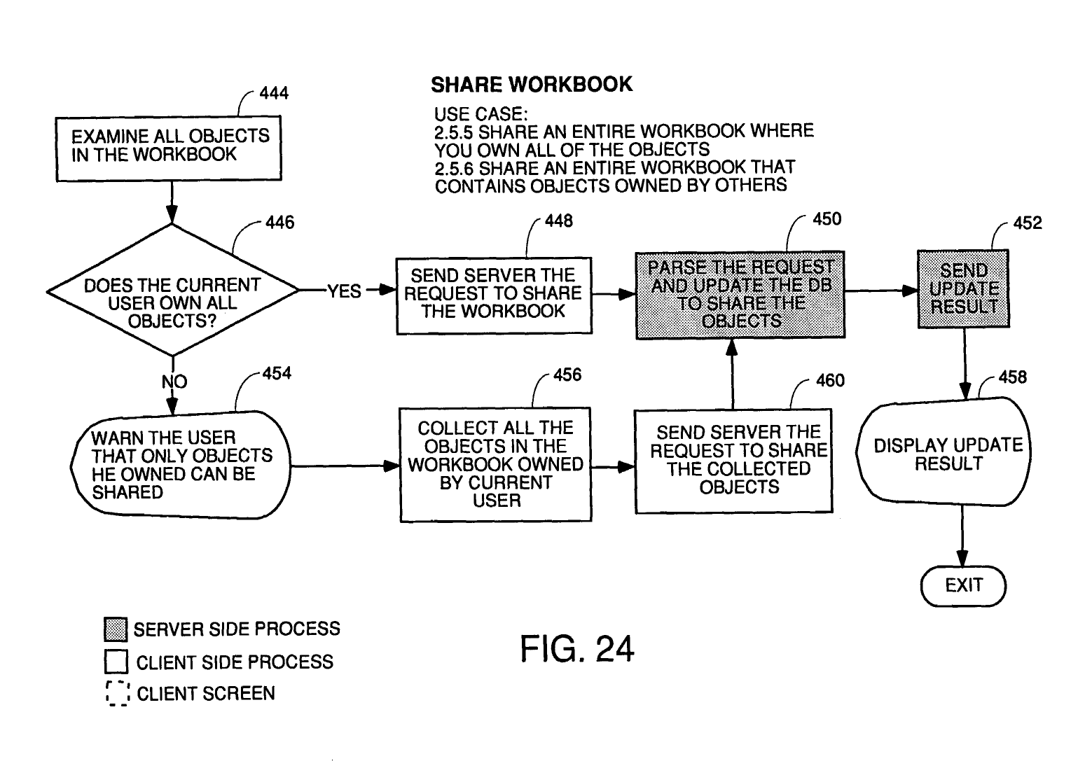

FIG. 24 is a flowchart of the process to share a workbook. This process is performed when the user chooses menu option 35 in FIG. 4. Step 444 represents a step by the client computer to examine all objects in the workbook. Test 446 represents the client side process of examining the metadata for each found object to determine if the user owns all the objects in the workbook. If he does, step 448 is performed by the client to send a request to the master library application on the server to share the workbook. Step 450 is then performed by the server to parse the request and update the database records for the workbook and all the objects in it to indicate all the objects and the workbook that contains them are shared. Step 452 is performed by the server to send the results of the share action back to the client add-in process, and the client add-in process displays the results of the share process in step 458.

If test 446 determines that not all the objects in the workbook are owned by the current user, step 454 is performed by the client computer to warn the user that only objects he owns can be shared. Step 456 is then performed by the client process to collect all the objects in the workbook owned by the current user. The client then sends the server the request to share the collected objects and identifies the collected objects in some way in step 460. The server then performs step 450 to parse the share workbook request and update the database of objects in the master library to indicate the collected objects are to be shared.

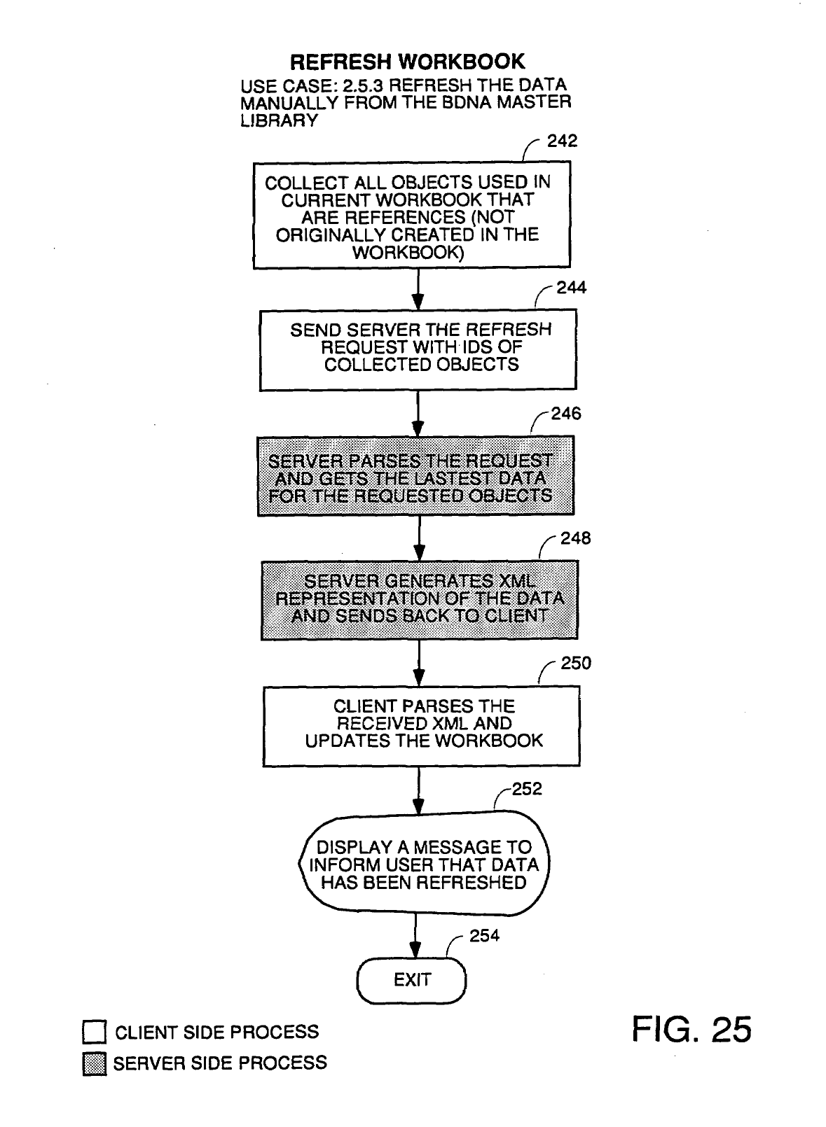

FIG. 25 is a flowchart of the process to refresh a workbook. This process is performed when the user selects the Refresh workbook menu option 26 in FIG. 4. Step 242 represents the process of collecting all the objects used in the current workbook on the client machine that are references. References are objects not originally created in the current workbook open on the client machine but which are imported therein from the master library. Step 244 represents the process of sending the server the Refresh Request along with the list of IDs of the collected reference objects. Steps 242 and 244 are client side steps carried out by the software on the client computer.

Step 246 is the server side process of parsing the request and getting the latest data for each of the requested objects. Typically this is done by sending a request to the client machine which created each object to get the latest state of that object. This process will return the latest value or constant for each cell and the latest formula and references to other cells if the cell is programmed with a formula. In step 248, the server master library process creates an XML description of each object which has been refreshed and sends the XML description of the refreshed object to the client which requested the refresh through its Excel add-in application. In step 250, the client Excel add-in receives the XML description of each refreshed object and recreates the refreshed object from the XML description. The original object is then replaced in the workbook with the refreshed version thereof. In step 252, the add-in displays a message that the data has been refreshed, and the process then exits in step 254.

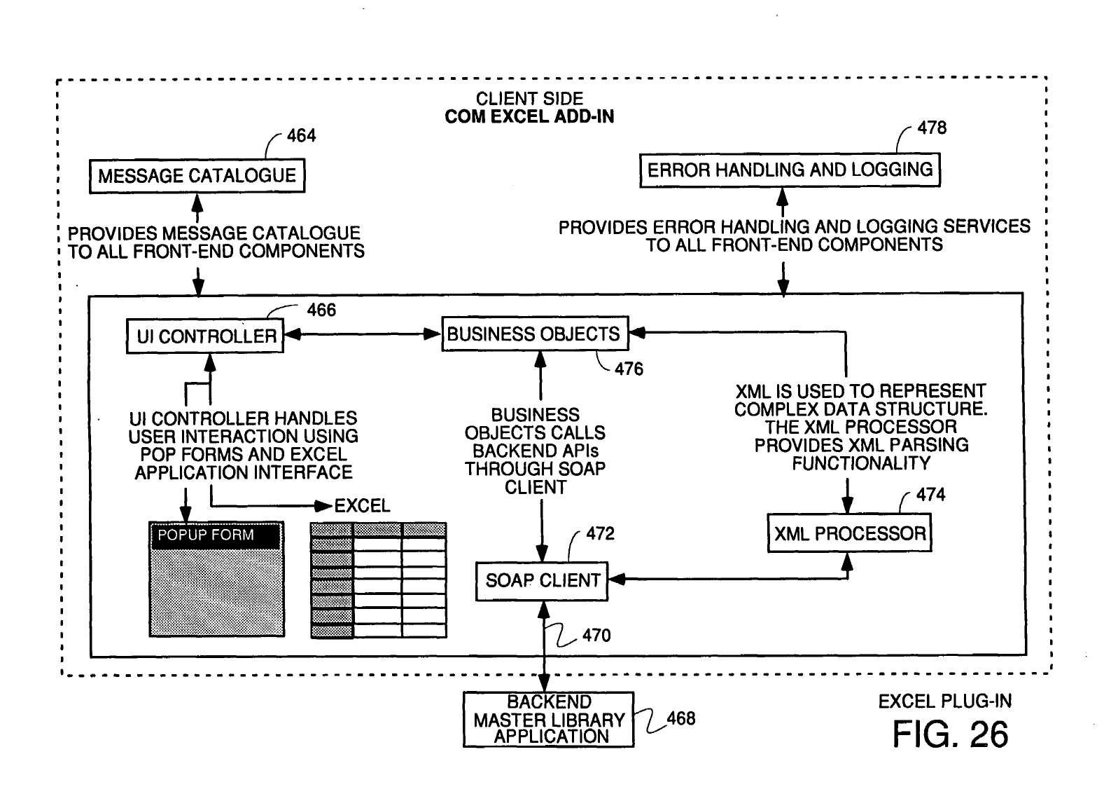

FIG. 26 is a software architecture diagram of the Excel plug in referred to in the diagram as a COM Excel Add-In because it is designed to use the COM interface to add functionality to Excel application programs. The COM interface is a well known interface published by Microsoft for various ones of its application programs which allows a user to add objects which can communicate with the objects in the application program (such as Excel in this case) and invoke certain functions and supply arguments for those function calls, request data or enter data. The add-in has a message catalog 464 which stores messages to all front-end components to allow the add-in to display various messages. A user-interface controller 466 controls the client computer to handle user interaction using popup forms to solicit the user to enter data and menu selections and using the Excel application interface. The add-in also communicates with the backend master library application 468 running on the server, as represented by line 470 between the master library application 468 and the SOAP client 472. The SOAP client represents all the SOAP communication protocols to communicate over whatever data path such as a local area network which exists between the client computer and the backend process 468 running on the server.

The Soap client 472 bidirectionally communicates with an XML processor 474 which functions to do XML parsing functionality for communications in both directions between the client add-in and the master library application. Thus, whenever the client add-in sends workbook objects to the master library for storage, those objects are converted in XML descriptions in the XML processor 474 for transmission over the data path. Likewise, when the client desires to import a shared object from the master library, the master library applications sends an XML description of the object to the client add-in and the XML processor converts that XML description into a workbook object that can be inserted into the workbook being constructed on the client computer. The business objects process 476 represents the plug in process to send workbook objects for storage in the master library and to import workbook objects from the master library and insert them at an insertion point designated by the user. The business objects process 476 invokes backend API function calls to send objects to the master library, save objects to the master library, share objects sent from the workbook to the master library and refresh objects in the current workbook open on the client that were not originally created in the workbook. The business objects process interacts with the user of the client plug in via the UI controller 466.

An error handling and logging process 478 provides error handling and logging services to all front end components.

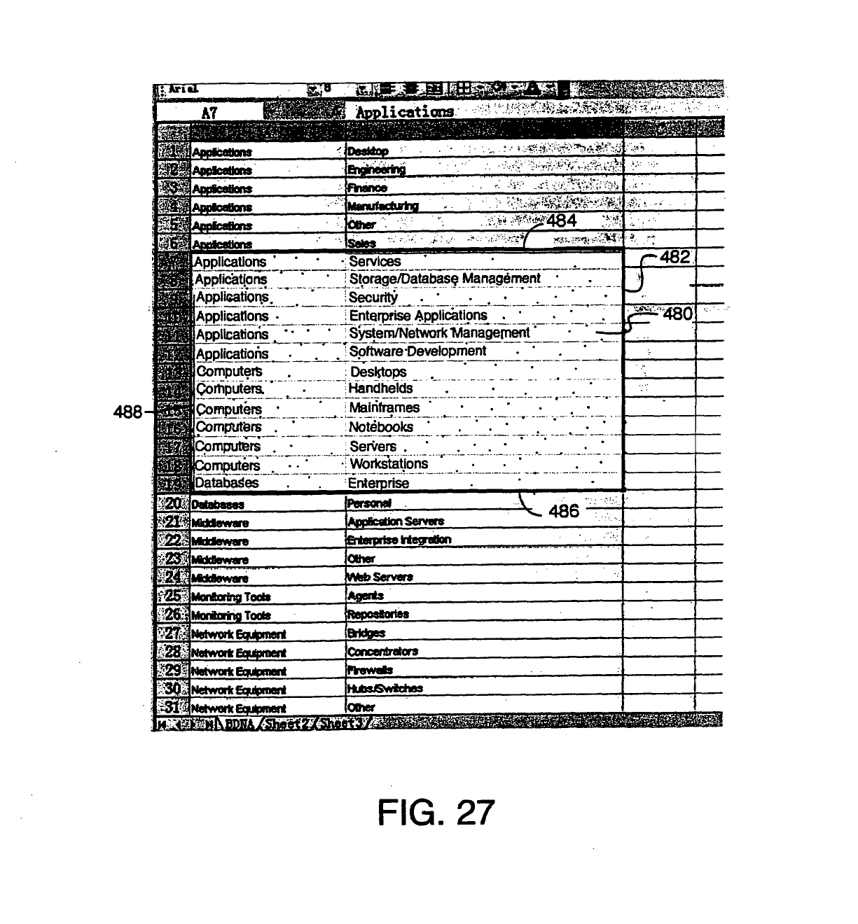

FIG. 27 is a screen shot of a user interface screen showing in the stippled region 480 the boundaries of a table object. The user can drag the boundary lines right side and bottom lines to different locations to expand or contract the number of cells in the table or can simply re-select the entire table.

Although the invention has been disclosed in terms of the preferred and alternative embodiments disclosed herein, those skilled in the art will appreciate that modifications and improvements may be made without departing from the scope of the invention. All such modifications are intended to be included within the scope of the claims appended hereto.

What is claimed is:

1. A client process to store a spreadsheet and its objects generated on a client computer in a master library on a server to which said client computer is coupled so as to enable sharing of said spreadsheet or one or more of its objects for viewing or insertion in one or more spreadsheets on any client computer coupled to said server, comprising the steps:
A) parsing a spreadsheet to identify all objects that make up said spreadsheet;
B) converting each object to a representation that can be transmitted over a data network to a server; and
C) sending said representation to said master library on said server.

2. The process of claim 1 further comprising the step of automatically assigning a unique name to every object parsed from each spreadsheet.

3. The process of claim 1 wherein step B) comprises converting each object to an XML description thereof.

4. The process of claim 1 wherein step B) comprises converting each object to SOAP representation.

5. The process of claim 1 further comprising the step of automatically capturing metadata created about objects by said spreadsheet and including said metadata in said representation of said object.

6. The process of claim 1 further comprising the steps of:
D) automatically capturing metadata created about objects by said spreadsheet;
E) including said metadata in said representation of said object, and displaying user interface mechanisms by which users can enter additional metadata about objects on a spreadsheet;
F) capturing any metadata entered by a user and including said user defined metadata in said description generated in step B.

7. One or more computer readable mediums having stored thereon computer instructions which, when executed by one or more computers control said computers to allow individual objects on a first spreadsheet existing on one of said computers to be imported into a second spreadsheet existing on one of said computers.

8. A client computer coupled to a server via any data path, said client computer programmed with an operating system, software to communicate over said data path, and a spreadsheet application and programmed to perform the following functions:
provide a user interface mechanism added onto said spreadsheet application's native user interface which allows a user to issue a command to save a spreadsheet to a master library on said server computer;
receive a user command to save a spreadsheet and respond thereto by:
parsing individual objects of said spreadsheet and assigning each object a name;
creating descriptions of each object and transmitting said descriptions to said server over any data path for decoding and recreation of the original object in a master library application running on said server.

9. A server computer coupled to a client computer by any data path, said server computer programmed with an operating system, software to communicate over said data path, said server computer:
further programmed with an application program to implement a master library application which controls said server computer to perform the following functions:
receive descriptions of objects parsed from a spreadsheet running on a client computer;
decode said description of each object and recreate said object in an emulation of a spreadsheet implemented by said master library application;
store said recreated object and all its metadata.

10. The server computer of claim 9 further programmed to create a link or mapping between each object stored in said emulation of a spreadsheet implemented by said master library such that all changes made to each object on a spreadsheet on a client computer can be imported into the corresponding object stored in said master library emulated spreadsheet.

11. A process carried out in an environment comprised of a client computer which is coupled via any data path to a server computer running a master library process, comprising:
receiving a command to save a spreadsheet created on a client computer in a master library;
parsing objects from said spreadsheet;
converting said parsed object into descriptions in a language that can be transmitted over any data path to a master library process running on said server computer;
sending said descriptions to said master library process;
converting said descriptions of said objects into spreadsheet objects and storing said spreadsheet objects in a master library.

12. The process of claim 11 further comprising the steps carried out on said server computer running said master library process of:
receiving a search command specifying the type of spreadsheet objects to search for in said master library and the type of search to perform and search criteria and identifying all objects in said master library of the sought after type satisfying the search criteria; and
creating descriptions of each object which met said search criteria and sending said descriptions to said client computer.

13. The process of claim 11 further comprising a sharing process comprising the steps of:
receiving a command to share spreadsheet objects;
responding to said command by determining if all said spreadsheet objects are owned by the current user of said client computer;
if all said spreadsheet objects are owned by said current user, sending a share request to said server computer to share said spreadsheet objects;
if not all said spreadsheet objects are owned by said current user, gathering all said spreadsheet objects which are owned by said current user and sending a share request to said server computer to share said gathered spreadsheet objects;
responding to said share request by annotating a database record for each object to indicate said object is shared.

14. The process of claim 13 further comprising the steps of:
receiving said request to download a spreadsheet object which has been indicated as shared and creating an XML description of said object at a detail level specified by said user as value only, value and formula only or all rollup details and sending said description to the client computer which made said download request;
converting said description of said object into a spreadsheet object and storing said object in a spreadsheet being constructed by a user of said client computer at a location specified by said user.

15. The process of claim 14 further comprising the steps of receiving commands of said user using a using interface of said spreadsheet into which said object was stored to alter said object and altering said object as requested.

16. The process of claim 15 further comprising the steps of receiving a command to save the spreadsheet having the modified downloaded object therein and responding thereto by saving said spreadsheet and all its individual objects in said master library.

17. The process of claim 16 further comprising the steps of receiving a command to share user specified objects of a spreadsheet to a master library and responding by creating and sending descriptions of the objects to be shared to said master library process on said server computer where the descriptions are converted back into spreadsheet objects and stored in said master library.

18. The process of claim 16 wherein when said save command is received, all objects in said master library which also exist on said spreadsheet are synchronized to the current state of the corresponding object on said spreadsheet.

19. A process carried out on a client computer which is coupled via any data path to a server computer running a master library process, comprising:
receiving a request from a user to open a master library;
displaying one or more user interface mechanisms to allow a user to select the type of spreadsheet object to search for and the manner of search;
displaying spreadsheet objects returned as a result of said search.

20. One or more computer readable mediums having stored thereon computer instructions which, when executed by one or more computers control said computers to allow individual objects on a first spreadsheet existing on one of said computers to be stored in a master library application running on a second computer and downloaded from said master library to a spreadsheet application running on another computer.

21. A spreadsheet object sharing process comprising the steps:
A) upon receiving a command, parsing individual objects on a first spreadsheet existing a first computer which are to be stored in a master library application running on a second computer;
B) converting said parsed objects to a description that can be transported to a second computer and sending said descriptions to said second computer;
C) converting said descriptions to spreadsheet objects on said second computer and storing said descriptions in a master library as shared object\ts;
D) receiving a request to download an object stored on said second computer and converting the requested object to a description that can be sent over a data path to the computer which requested download of said object and transmitting said description;
E) at a computer which requested download of said object from said master library, converting the received description of the object into a spreadsheet object and storing said object in a spreadsheet.

22. The process of claim 21 further comprising executing on said first computer a plug-in program which adds user interface menus, commands and displays which are specific to said spreadsheet object sharing process to the normal user interface menus, commands and displays of said spreadsheet.

23. The process of claim 22 wherein said plug-in controls said first computer to add said user interface menus, commands and displays to an Excel spreadsheet.

24. The process of claim 21 wherein step B comprises converting each parsed object into an XML description.

25. A computer-readable medium having stored thereon computer-readable instructions which can control a computer to perform the following process:
A) parsing a spreadsheet to identify all objects that make up said spreadsheet, and automatically assigning a name to each object;
B) converting each object to a representation that can be transmitted over a data network to a server; and
C) sending said representation to said master library on said server.

26. The computer-readable medium of claim 25 wherein said instructions control said computer to automatically name each parsed object and provide a user interface to allow a user to interact in the naming process, said name serving to enable mapping said object to its original location in the spreadsheet in which it was created and from which the object came.

27. A server process to receive information defining objects that make up a spreadsheet on a client computer and store said information in a master library, comprising the steps:
receiving in a server coupled to one or more client computers by a network a description of each object that comprises a spreadsheet;
parsing each received description of an object and converting each description into an object of a spreadsheet and storing said object in a master library on said server, and storing an automatically generated name for said object which provides a basis to map said object back to the original object on a spreadsheet of a client computer.

28. The process of claim 27 further comprising the steps:
refreshing the objects stored in said master library with the latest information from a corresponding object of a spreadsheet on a client computer where the object in said master library being refreshed was originally created.

29. The process of claim 27 further comprising the steps:
sending a request to refresh an object in a spreadsheet on a client computer which have been downloaded from said master library;
receiving said request and refreshing an object corresponding to said object to be refreshed, said corresponding object being stored in said master library, said refreshing of said corresponding object being accomplished by obtaining the latest information from a corresponding object of a spreadsheet on a client computer where the corresponding object in said master library was originally created
creating in said server computer a description of the refreshed object in said master library after it is refreshed and sending said description to said client computer; and
converting said description of said refreshed object received from said server to a spreadsheet object and replacing the object in said client computer spreadsheet for which the request to refresh was made with the refreshed object decoded from the description of the refreshed object received from the server computer.

30. The process of claim 29 further comprising the steps:
creating a subscription for each cell or cell in a table which has been downloaded into a spreadsheet on a client computer and refreshing every cell imported from said master library using the process of claim 29 each time the user gives a refresh command such that each time the original creator of a spreadsheet object changes it, the changes are propagated throughout the organization through said subscriptions.
